(19) United States
(12) Patent Application Publication
(10) Pub. No.: US 2026/0047519 A1
(43) Pub. Date: Feb. 19, 2026

(54) WALK-BEHIND WORKING MACHINE

(71) Applicant: Nanjing Chervon Industry Co., Ltd., Nanjing (CN)

(72) Inventors: Jifeng Feng, Nanjing (CN); Chao Xian, Nanjing (CN); Zhe Chen, Nanjing (CN); Toshinari Yamaoka, Nanjing (CN); Qi Zhang, Nanjing (CN); Shichang Fu, Nanjing (CN); Xiaozhe Zhao, Nanjing (CN); Yan Jin, Nanjing (CN); Chao Yang, Nanjing (CN); Siyi Li, Nanjing (CN)

(21) Appl. No.: 19/316,437

(22) Filed: Sep. 2, 2025

Related U.S. Application Data
(63) Continuation-in-part of application No. 18/470,206, filed on Sep. 19, 2023.
Application No. 18/470,206 is a continuation-in-part of application No. PCT/CN2022/124869, filed on Oct. 12, 2022.

(30) Foreign Application Priority Data
Nov. 1, 2021 (CN) 202111284012.8
Dec. 8, 2021 (CN) 202123106186.3
Jul. 26, 2022 (CN) 202221939497.X
Apr. 28, 2023 (CN) 202321027033.6
Apr. 28, 2023 (CN) 202321044063.8
Jul. 21, 2025 (CN) 202511009364.0

(51) Int. Cl. A01D 34/82; A01D 34/00; A01D 101/00

(52) U.S. Cl. CPC A01D 34/824; A01D 34/006; A01D 2101/00

(57) ABSTRACT

A walk-behind working machine. The walk-behind working machine includes a body including a walking assembly and a drive assembly for driving the walking assembly; a handle device including a grip for a user to hold; and a connecting rod assembly for connecting the body to the handle device. The walk-behind working machine further includes a display capable of displaying information related to the walk-behind working machine. In this manner, it is convenient for the user to acquire the work information of a working machine, thereby improving the convenience of use of the user.

### RELATED APPLICATION INFORMATION

This application is a continuation-in-part of U.S. application Ser. No. 18/470,206, filed on Sep. 19, 2023, which is a continuation-in-part of International Application Number PCT/CN2022/124869, filed on Oct. 12, 2022, through which this application also claims the benefit under 35 U.S.C. § 119 (a) of Chinese Patent Application No. 202111284012.8 filed with the China National Intellectual Property Administration (CNIPA) on Nov. 1, 2021, Chinese Patent Application No. 202123106186.3 filed with the CNIPA on Dec. 8, 2021, and Chinese Patent Application No. 202221939497.X filed with the CNIPA on Jul. 26, 2022.

Through U.S. application Ser. No. 18/470,206, this application also claims the benefit under 35 U.S.C. § 119 (a) of Chinese Patent Application No. CN 202321044063.8, filed on Apr. 28, 2023, and Chinese Patent Application No. CN 202321027033.6, filed on Apr. 28, 2023.

This application also claims the benefit under 35 U.S.C. § 119 (a) of Chinese Patent Application No. CN 202511009364.0, filed on Jul. 21, 2025.

The disclosure of each of these references is incorporated herein by reference in its entirety.

### TECHNICAL FIELD

The present application relates to a power tool and, in particular, to a walk-behind working machine.

### BACKGROUND

A walk-behind working machine may be a machine for a user to perform garden work, specifically a working machine such as a mower or a snow thrower that can work in grasslands, snowfields, or other environments and has a pushable function.

In the walk-behind working machine on the market, one or more separate buttons are generally used to control various functions of the machine. Many walk-behind working machines cannot remind the user of the current working mode of the working machine, and the user needs to determine the working state of the working machine through the experience obtained during the long-term operation. For example, for some mowers, after the user adjusts the rotational speed of the blades of the mower, the only method for determining whether the blades are adjusted to an appropriate rotational speed is to hear a louder sound made by the mower. However, being able to do this skillfully requires the user to accumulate certain operating experience, which may not be possible for the user who uses the machine tool less frequently. Moreover, some walk-behind working machines feed back the working state information of the working machine to the user in the form of relatively independent indicator lights being lit or extinguished.

### SUMMARY

A walk-behind working machine includes a body including a walking assembly and a drive assembly for driving the walking assembly; a handle device including a grip for a user to hold; and a connecting rod assembly for connecting the body to the handle device. The walk-behind working machine further includes a display capable of displaying information related to the walk-behind working machine.

In an example, the display is configured to be slidably and/or rotatably connected to the handle device.

In an example, the walk-behind working machine further includes a self-traveling mode switch, where the self-traveling mode switch is capable of adjusting the walk-behind working machine to a self-traveling mode, and in the self-traveling mode, the walk-behind working machine is capable of adjusting the self-traveling speed according to the magnitude of the thrust applied by the user.

In an example, the walk-behind working machine further includes a blade mode switch capable of controlling the rotational speed of a blade of the walk-behind working machine.

In an example, self-traveling mode information of the walk-behind working machine is displayed on the display.

In an example, blade mode information of the walk-behind working machine is displayed on the display.

In an example, light information of the walk-behind working machine is displayed on the display.

In an example, power information of the walk-behind working machine is displayed on the display.

In an example, fault information of the walk-behind working machine is displayed on the display.

In an example, the walk-behind working machine is connected to an electronic device of the user via Bluetooth, and information about the electronic device is displayed on the display.

In an example, the display is detachably connected to the handle device.

In an example, the handle device includes a switch box, and an electronic component for controlling a working state of a working element is disposed in the switch box.

In an example, the display is configured to be slidably or rotatably connected to the handle device.

In an example, only one side of the display is connected to the handle device.

In an example, the display includes a bottom at a bottom end, and the bottom of the display is connected to the switch box.

In an example, the display includes a top at a top end, and the top of the display is connected to the grip.

In an example, the display includes a display interface for presenting information about the walk-behind working machine to the user, and the display viewed from a direction perpendicular to the display interface has at least an upper boundary and a lower boundary, where the upper boundary is basically parallel to the lower boundary, and the lower boundary is connected to the switch box.

In an example, a first middle plane is defined as a plane perpendicular to a paper surface, the first middle plane extends along the left and right direction of the walk-behind working machine, and the grip is basically symmetrical about the first middle plane; a second middle plane is defined as a plane perpendicular to the paper surface, the second middle plane extends along the left and right direction of the walk-behind working machine, and the display is basically symmetrical about the second middle plane; and the first middle plane is basically parallel to the second middle plane.

In an example, the included angle between the first middle plane and the second middle plane is less than or equal to 45 degrees.

In an example, the walk-behind working machine further includes a telescopic rod assembly, where the telescopic rod assembly is telescopically adjusted, the telescopic rod assembly connects the body to the handle device, and the second middle plane is basically perpendicular to the telescopic rod assembly.

In an example, the walk-behind working machine is a mower.

The present application further provides the technical solutions described below. A walk-behind working machine includes a body including a walking assembly and a drive assembly for driving the walking assembly; a handle device including a grip for a user to hold; and a connecting rod assembly for connecting the body to the handle device. The walk-behind working machine further includes a display capable of displaying information related to the walk-behind working machine. The display is configured to be slidably and/or rotatably connected to the handle device.

The present application further provides the technical solutions described below. A walk-behind working machine includes a body including a walking assembly and a drive assembly for driving the walking assembly; a handle device including a grip for a user to hold; and a connecting rod assembly for connecting the body to the handle device. The walk-behind working machine further includes a display capable of displaying information related to the walk-behind working machine. Only one side of the display is connected to the handle device.

The present application further provides the technical solutions described below. A walk-behind working machine includes a motor; a grip device for a user to hold; and a telescopic rod assembly that is capable of being extended or shortened and includes a first telescopic rod assembly and a second telescopic rod assembly. The walk-behind working machine further includes a locking device. The locking device includes a locking assembly, where the locking assembly includes a first locking assembly and a second locking assembly, where the first locking assembly and the second locking assembly are used for locking or releasing the first telescopic rod assembly and the second telescopic rod assembly, respectively; a locking rod for connecting the first locking assembly to the second locking assembly, where the first locking assembly and the second locking assembly are separately located at two ends of the locking rod; and an operating member located on the locking rod and used for the user to operate the locking assembly, where the locking device includes at least one operating member, and when the user operates the operating member, both the first telescopic rod assembly and the second telescopic rod assembly are locked or released together.

In an example, the locking assembly includes a lock driven by the locking rod, where the lock is displaced along the axial direction of the locking rod.

In an example, the locking assembly further includes a second rotary member.

The second rotary member includes a first rotary portion and a second rotary portion. The first rotary portion is driven by the locking rod to rotate, and the second rotary portion mates with a third rotary portion of the lock, so as to drive the lock to move.

In an example, the locking assembly further includes a second elastic member accommodated in an accommodation space. When the second elastic member is deformed under pressure, the second elastic member applies a certain friction to the telescopic rod assembly to prevent the length of the telescopic rod assembly from changing.

The present application further adopts the technical solutions described below. A walk-behind working machine includes a body including a working element for implementing a function of the walk-behind working machine; and an operating device connected to the body and used for a user to operate the walk-behind working machine on the rear side of the walk-behind working machine. The operating device includes a switch box, and an electronic component for controlling a working state of the working element is disposed in the switch box. The walk-behind working machine further includes a first mounting portion disposed on the switch box and a second mounting portion detachably connected to the first mounting portion, where the second mounting portion is connected to or formed on an attachment.

In an example, the operating device further includes a handle for the user to push the walk-behind working machine to travel, and the switch box is fixed to the handle.

In an example, the handle includes a grip for the user to hold; and a connecting rod for connecting the grip to the body. One end of the switch box is fixed to the grip, and the other end of the switch box is fixed to the connecting rod.

In an example, the first mounting portion and the second mounting portion are connected in a snap-fit manner.

In an example, the first mounting portion is a mounting hole opened on the switch box, and a snap mating with the mounting hole is disposed on the second mounting portion.

In an example, the first mounting portion is a snap disposed on the switch box, and a mounting hole mating with the snap is disposed on the second mounting portion.

In an example, the second mounting portion is a mounting plate, and the mounting plate and the first mounting portion are connected in a snap-fit manner.

In an example, the mounting plate and the attachment are detachably connected by a screw.

In an example, the attachment includes one of a storage box, a phone holder, a cup holder, and a fan.

In an example, the grip includes a first grip and a second grip that are connected, where the first grip and the second grip are symmetrical about a symmetry plane, and the phone holder is located between the first grip and the second grip.

### BRIEF DESCRIPTION OF DRAWINGS

FIG. 1 is a perspective view of a walk-behind working machine;

FIG. 2 is a perspective view of a display, a handle device, and part of a connecting rod assembly of the walk-behind working machine in FIG. 1 from a certain perspective;

FIG. 3 is a perspective view of the display, the handle device, and part of the connecting rod assembly of the walk-behind working machine in FIG. 2 from another perspective;

FIG. 4 is a partial enlarged view of the display and function keys of the walk-behind working machine in FIG. 3;

FIG. 5 is a schematic view of a display in a walk-behind working machine as an example;

FIG. 6 is an exploded view of the structure of the display in FIG. 5 from a certain perspective;

FIG. 7 is a partial assembly schematic view of a display from another perspective;

FIG. 8 is a partial enlarged view of a snap on the display in FIG. 4;

FIG. 9 is an exploded view of the display in FIG. 4 as an example from a certain perspective;

FIG. 10 is an exploded view of the display in FIG. 4 from another perspective;

FIG. 11 is a schematic view of a light guide portion of the display in FIGS. 9 and 10;

FIG. 12 is an exploded view of a display as an example;

FIG. 13 is a side sectional view of the display shown in FIGS. 9 and 10;

FIG. 14 is a perspective view of a length-adjustable telescopic rod structure;

FIG. 15 is an exploded view of a telescopic rod structure from a certain perspective as a first example;

FIG. 16 is a perspective view of a locking assembly in FIG. 15 in a first state;

FIG. 17 is a side sectional view of a locking assembly in FIG. 15 in a first state;

FIG. 18 is an exploded view of a locking rod and a first locking assembly in

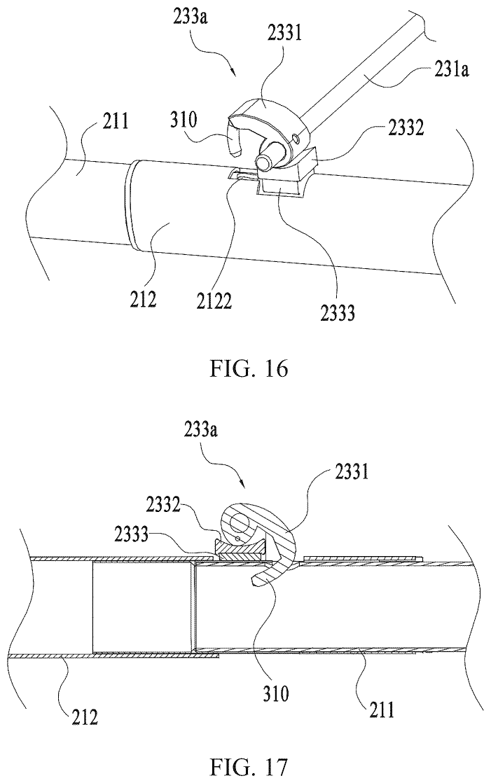

FIG. 16;

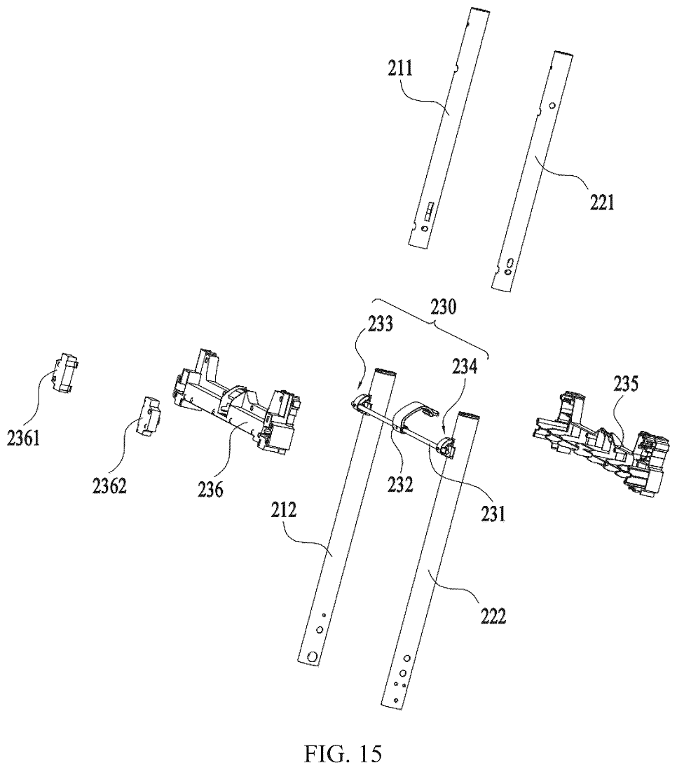

FIG. 19 is a schematic view of a locking rod and an operating member in FIG. 15;

FIG. 20 is a partial schematic view of an example of a locking rod;

FIG. 21 is a side sectional view when the locking rod in a telescopic rod structure in FIG. 20 mates with a first rotary member;

FIG. 22 is an exploded view of a telescopic rod structure as a second example;

FIG. 23 is an exploded view of a locking rod and a first locking assembly in FIG. 22 from a certain perspective;

FIG. 24 is an exploded view of a locking rod and a first locking assembly in FIG. 22 from another perspective;

FIG. 25 is a side sectional view of a locking assembly in FIG. 22 in a first state;

FIG. 26 is a side sectional view of a locking assembly in FIG. 22 in a first state;

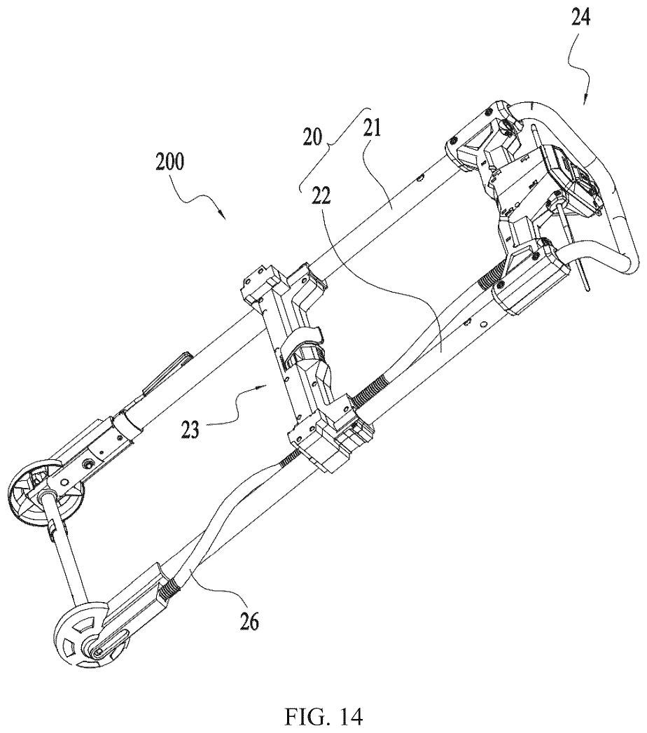

FIG. 27 is a schematic view when an operating handle in FIG. 14 is at another position;

FIG. 28 is an exploded view as an example of a telescopic rod assembly;

FIG. 29 is a schematic view of a walk-behind working machine;

FIG. 30 is a structural view of a walk-behind working machine according to an example of the present application;

FIG. 31 is a structural view of an operating device according to an example of the present application;

FIG. 32 is a partial structural view of an operating device according to an example of the present application;

FIG. 33 is a schematic view illustrating the connection relationship between a storage box and a second mounting portion when an attachment is the storage box according to an example of the present application;

FIG. 34 is a structural view of a second mounting portion according to an example of the present application;

FIG. 35 is structural view one of an operating device when an attachment is a phone holder according to an example of the present application;

FIG. 36 is structural view two of an operating device when an attachment is a phone holder according to an example of the present application;

FIG. 37 is a structural view of an operating device when an attachment is a cup holder according to an example of the present application;

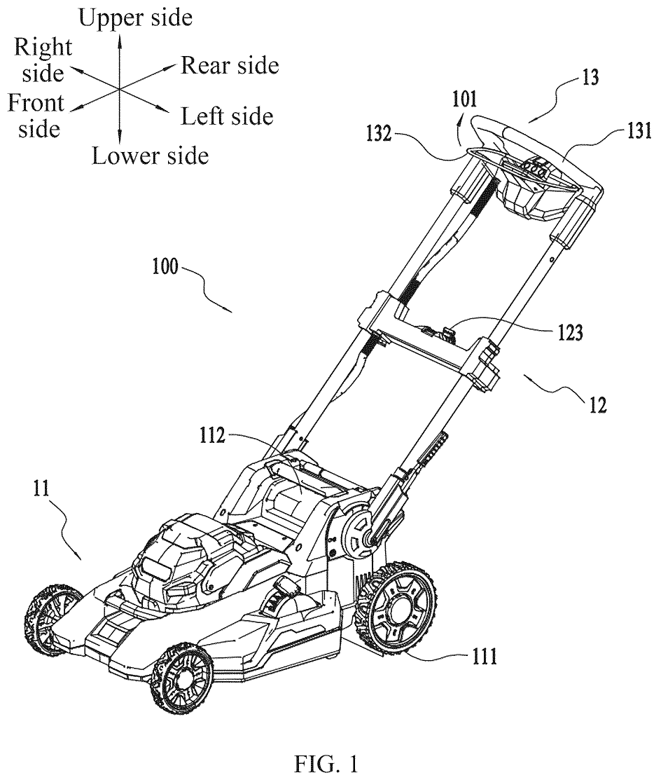

FIG. 38 is a side view of the walk-behind working machine in FIG. 1;

FIG. 39 is a partial enlarged view of FIG. 38;

FIG. 40 is a schematic view of a display of the walk-behind working machine in FIG. 1;

FIG. 41 is a schematic view of a mounting structure used for mounting a display on a handle device;

FIG. 42 is a structural view of a walk-behind mower according to the present application;

FIG. 43 is a partial structural view of a walk-behind mower according to the present application;

FIG. 44 is a side view of a connecting rod assembly, a holding handle, and a display according to the present application;

FIG. 45 is a schematic view of a mounting structure of a display according to the present application;

FIG. 46 is a schematic view of another mounting structure of a display according to the present application;

FIG. 47 is a schematic view of another mounting structure of a display according to the present application;

FIG. 48 is a partial structural view of FIG. 47;

FIG. 49 is a structural view illustrating that a display is mounted on a holding handle according to the present application;

FIG. 50 is another structural view of a connecting rod assembly according to the present application;

FIG. 51 is a partial structural view of FIG. 50;

FIG. 52 is a side view of a walk-behind mower in a folded state according to the present application;

FIG. 53 is a top view of a walk-behind mower in a folded state according to the present application;

FIG. 54 is a structural view of a display according to the present application;

FIG. 55 is an exploded view of a display according to the present application;

FIG. 56 is a schematic view of the content displayed on a display surface of a display according to the present application;

FIG. 57 is a side view of a walk-behind mower according to the present application;

FIG. 58 is a first type of structural view illustrating that a display is disposed on a body according to the present application;

FIG. 59 is a second type of structural view illustrating that a display is disposed on a body according to the present application;

FIG. 60 is a third type of structural view illustrating that a display is disposed on a body according to the present application;

FIG. 61 is a fourth type of structural view illustrating that a display is disposed on a body according to the present application;

FIG. 62 is a schematic view of another example of a storage box according to the present application;

FIG. 63 is a schematic view illustrating that a cover of the storage box in FIG. 62 is opened;

FIG. 64 is a schematic view of another example of a storage box according to the present application;

FIG. 65 is a schematic view illustrating the dimension of a storage box according to the present application;

FIG. 66 is a structural diagram of a walk-behind working machine provided by another embodiment of the present application;

FIG. 67 is a structural diagram of the walk-behind working machine shown in FIG. 66, with its display in a folded state;

FIG. 68A is a schematic diagram of a display in an unfolded state provided by an embodiment of the present application;

FIG. 68B is a schematic diagram of the display shown in FIG. 68A in a folding state and in a fully folded state;

FIG. 69A is a schematic diagram of a display in an unfolded state provided by another embodiment of the present application;

FIG. 69B is a schematic diagram of the display shown in FIG. 69A in a folding state;

FIG. 70 is a schematic diagram of another type of display formed by a plurality of screens, according to an embodiment of the present application;

FIG. 71 is a schematic diagram of another display folding structure (up-down folding) according to an embodiment of the present application;

FIG. 72 is a structural diagram of the display mounted on a transverse connection structure according to an embodiment of the present application;

FIG. 73 is a schematic diagram of a handle device when the body of the walk-behind working machine is horizontal according to an embodiment of the present application;

FIG. 74 is a schematic diagram of the handle device shown in FIG. 73 in a tilted state;

FIG. 75 is a structural diagram of a walk-behind lawn mower according to an embodiment of the present application;

FIG. 76 is a structural diagram of a control panel and a display according to an embodiment of the present application;

FIG. 77 is a schematic diagram of the indicator zones on the display provided by an embodiment of the present application;

FIG. 78 is a schematic diagram of a suspended display structure according to an embodiment of the present application;

FIG. 79 is a schematic diagram of the whole machine structure with the suspended display according to an embodiment of the present application;

FIG. 80 is a structural diagram of a display mounted on the body of a lawn mower according to an embodiment of the present application; and

FIG. 81 is a structural diagram of the lawn mower shown in FIG. 80 in a folded state.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

FIG. 1 shows a walk-behind working machine, specifically a working machine such as a mower or a snow thrower that can work in grasslands, snowfields, or other garden environments and has a pushable function. As an optional example, the mower is used as an example for description.

As shown in FIG. 1, a mower 100 mainly includes a body 11, a handle device 13, and a connecting rod assembly 12. The body 11 includes a walking assembly 111 and a drive assembly (not shown in the figure) for driving the walking assembly 111. The handle device 13 includes a grip 131 for a user to hold. The connecting rod assembly 12 connects the body 11 to the handle device 13. It is to be understood that another walk-behind working machine such as the snow thrower may also include the handle device 13, the body 11, the walking assembly 111, the grip 131, and other components. In this example, the walking assembly is a wheel assembly.

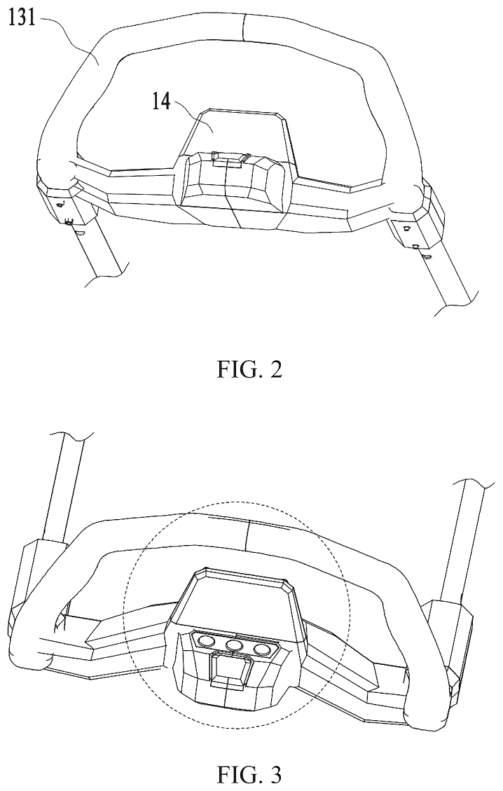

In an example, a display 14 (see FIG. 2) is located on the handle device 13 and connected to the grip 131. It is to be noted that the position of the display 14 is not limited to being fixed on the handle device 13, and the display 14 may also be configured to be slidably or rotatably connected to the grip 131 of the handle device 13. For example, the angle of the display 14 is adjusted according to the requirements of the user, or the display 14 not in need is folded by sliding or rotating. The display 14 may also be configured to be located on the connecting rod assembly 12 or the body 11. The specific position and connection manner of the display 14 are not limited.

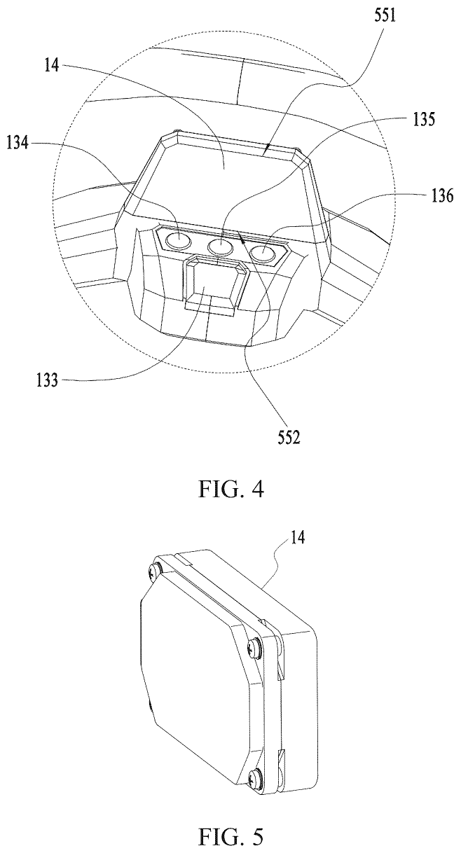

As shown in FIG. 4, the mower 100 includes a display switch 133. When the display switch 133 is activated, the display 14 is lit, and the relevant information of the mower 100 is displayed on the display 14.

In an example, the mower 100 involved in this example includes a self-traveling mode switch 136. The self-traveling mode switch 136 is capable of adjusting the mower 100 to a self-traveling mode, and in the self-traveling mode, the mower 100 is capable of adjusting the self-traveling speed according to the magnitude of the thrust applied by the user. In addition, the mower 100 may be adjusted to a hand-push mode by adjusting the self-traveling mode switch 136. In the hand-push mode, the mower 100 cannot travel independently and relies on only the push force applied by the user to move. When the user triggers the display switch 133 to light up the display 14, the current self-traveling mode information of the mower 100 is displayed on the display 14. At this time, if the user triggers the self-traveling mode switch 136 to adjust the mower 100 to the self-traveling mode, for example, from the hand-push mode to the self-traveling mode, the display 14 correspondingly displays that the mower 100 is changed from the hand-push mode to the self-traveling mode.

In an example, the mower 100 involved in this example includes a blade mode switch 134 controlling the rotational speed of the blade of the mower 100. When the display 14 is lit, the blade mode switch 134 is pressed, and then the mower 100 enters a constant low-speed mode, an automatic variable speed mode, and a constant high-speed mode in sequence. In the constant low-speed mode, the blades of the mower 100 rotate at a constant lower speed. In the automatic variable speed mode, the rotational speed of the blades of the mower 100 is automatically adjusted according to the magnitude of the resistance, and this mode is the default working mode of the mower 100. In the constant high-speed mode, the blades of the mower 100 rotate at a constant higher speed. When the user triggers the display switch 133 to light up the display 14, the current blade mode information of the mower 100 is displayed on the display 14. At this time, if the user triggers the blade mode switch 134 to adjust the blade mode of the mower 100, for example, from the automatic variable speed mode to the constant low-speed mode, the display 14 correspondingly displays that the mower 100 is changed from the automatic variable speed mode to the constant low-speed mode.

The mower 100 involved in this example further includes a folding switch 112, a telescopic switch 123, and a body switch 132. The folding switch 112 is used for controlling whether the mower 100 is foldable, the telescopic switch 123 is used for controlling whether the connecting rod assembly 12 of the mower 100 is telescopic, and the body switch 132 is used for controlling the drive assembly located on the body 11. In this example, the body switch 132 is a trigger 132, and the trigger 132 is rotatable along a first direction 101 (see FIG. 1). Only after the display 14 is lit, the user can adjust the function modes of the mower 100 through the self-traveling mode switch 136, the blade mode switch 134, a headlamp switch 135, and the like. When the user adjusts the folding switch 112 and the telescopic switch 123 so that the mower 100 is in a state where the folding function and the telescopic function are locked at the same time, the user closes the trigger 132 and the grip 131 of the handle device 13 to activate the drive assembly so that the mower 100 enters a cutting working state. In the working state of the mower 100, the trigger 132 needs to be kept in the closed state all the time. If the user releases the trigger 132 during operation, the drive assembly of the mower 100 stops supplying power so that the mower 100 stops the cutting operation.

In an example, light information of the walk-behind working machine is displayed on the display 14. In this example, the headlamp switch 135 (see FIG. 4) is used for controlling functions such as turning-on, turning-off, and brightness adjustment of the light of the mower 100. When the light of the mower 100 is on, this state is correspondingly displayed on the display 14. For example, if a first light of the mower 100 is on and a second light is off, the user can directly know whether a certain light is on through the display 14. For another example, if a certain light of the mower 100 is adjusted from the first brightness to the second brightness by the user, a corresponding display is made on the display 14. Therefore, when the user uses the mower 100 to perform operations, the user can be more aware of the current working state of the light, which is conducive to flexibly adjusting the lighting state and brightness mode of the light by the user according to the situation without having to trigger a light switch multiple times to “detect” the current illumination mode.

In an example, power information of the mower 100 is displayed on the display 14. In this example, the drive assembly of the mower 100 includes a battery pack, so power-related information such as the current power and remaining power of the battery pack is displayed on the display 14. Here, the remaining power (that is, the available power) may be displayed in a form of the percentage of the remaining power in the total power when the battery pack is fully charged, may be displayed in a form of the available time of the remaining power in the current working mode or the default working mode of the mower 100, may be displayed in conjunction with graphics, schematic views, or the like, or may be expressed in a form that can be understood by other users and can reflect the power condition.

In an example, fault information of the mower 100 is displayed on the display 14. In this example, if a motor of the mower 100 fails to start due to a fault, a corresponding reminder is displayed on the display 14 to inform the user to start the motor after resolving the corresponding fault.

In an example, the display 14 is configured to be directly operated by the user to adjust the walk-behind working machine. In this case, the walk-behind working machine does not need to have specific function keys, such as the self-traveling mode switch 136 and the blade mode switch 134, and the user can directly touch the display 14 to adjust the working mode of the walk-behind working machine. In other examples, the function keys may be integrated together with the display 14 and integrated on the display 14.

In an example, the walk-behind working machine is connected to an electronic device of the user via Bluetooth, and information about the electronic device is displayed on the display 14. When the user connects the electronic device (such as a mobile phone) of the user to the walk-behind working machine via Bluetooth, some information about the electronic device connected by the user is displayed on the display 14, such as the weather display and incoming call reminder. For another example, when a severe weather warning occurs on the electronic device of the user, the display 14 of the mower 100 simultaneously sends a reminder to the user, foretelling that the weather will soon be unfavorable for outdoor working. It is to be understood that the electronic device of the user may also be connected to the walk-behind working machine through a specific connection line, not limited to the Bluetooth connection.

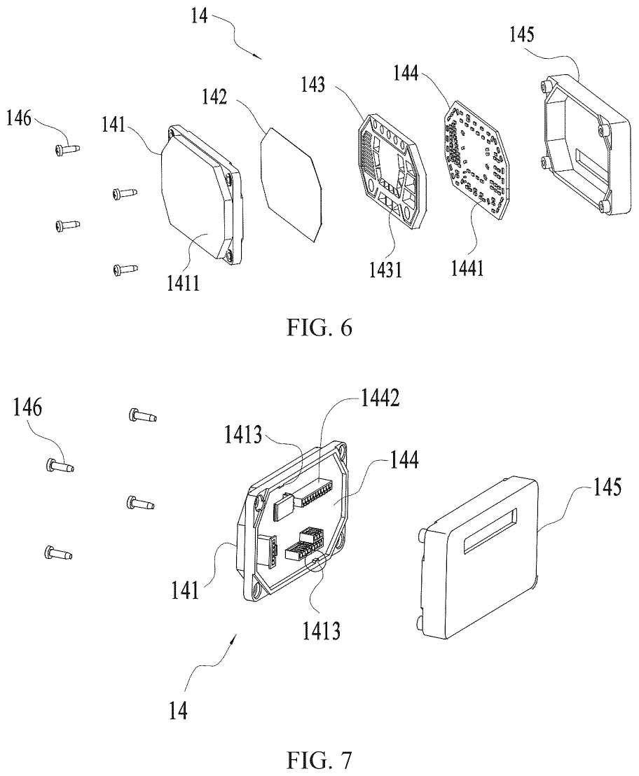

FIGS. 5 to 8 disclose a specific structure of the display 14 of the walk-behind working machine. The display 14 includes a circuit board 144, a transparent cover 141, an image portion 142, a light guide portion 143, and a fixed cover 145. The circuit board 144 includes a common component 1442 (see FIG. 7) for transmitting power and signals. Light emitters 1441 (see FIG. 6) are disposed on the circuit board 144. The light guide portion 143 basically covers the light emitters 1441. The transparent cover 141 has a certain degree of transparency. The circuit board 144 is located between the transparent cover 141 and the fixed cover 145.

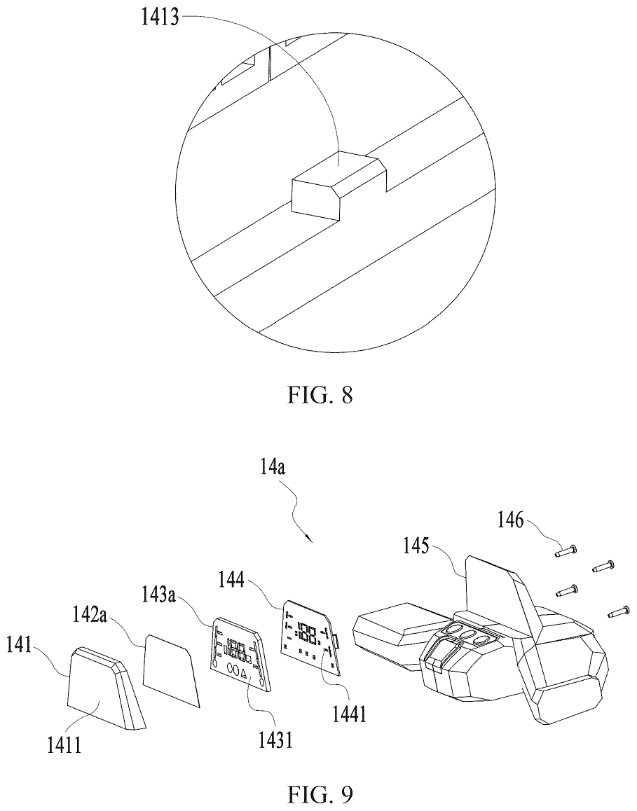

As shown in FIGS. 7 and 8, the image portion 142, the light guide portion 143, and the circuit board 144 are assembled together in the transparent cover 141 and fixed by a snap 1413. In this solution, screws 146 only need to fix the transparent cover 141 and the fixed cover 145, while other movable internal components are fixed by the transparent cover 141 through the snap 1413.

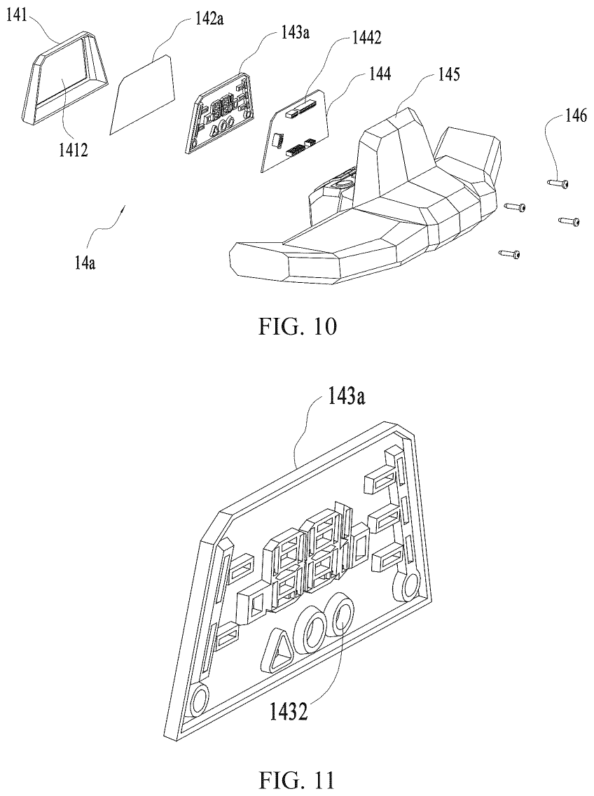

FIGS. 9 and 10 show an example in which the display 14 is applied on the mower 100, the image portion 142 is a type of image film 142a, and the image film 142a is located between the transparent cover 141 and the light guide portion 143 and is glued on a first surface 1431 of a light guide portion 143a. The light guide portion 143 is a light guide plate 143a, and the light guide plate 143a basically covers the light emitters 1441. The light emitters 1441 are light-emitting diodes (LEDs) in this example and may also be other luminous materials or electronic components, which is not limited here.

As shown in FIG. 11, light guide grooves 1432 are disposed on the light guide portion 143a to guide the propagation path of the light emitted by the light emitters 1441 and prevent the light emitted by different light emitters 1441 from interfering with each other. The light guide grooves 1432 have various shapes that are respectively used for reflecting different information such as characters, numbers, symbols, and indicator lights.

In this example, the transparent cover 141 and the fixed cover 145 of a display 14a are fixed together by the screws 146. In the figure, the holes through which the screws penetrate the circuit board 144, the light guide portion 143, and the image portion 142 and the threaded holes on the transparent cover 141 are omitted. Compared with the structure of the display 14 disclosed in FIGS. 5 to 8, in the actual application of this solution, when the light emitters 1441 on the circuit board 144 are arranged, the threads or holes required when the screws penetrate need to be avoided, and the opening of the screw holes on the circuit board 144 and the light guide portion 143 has a certain impact on the space utilization rate of the circuit board 144 and the light guide portion 143.

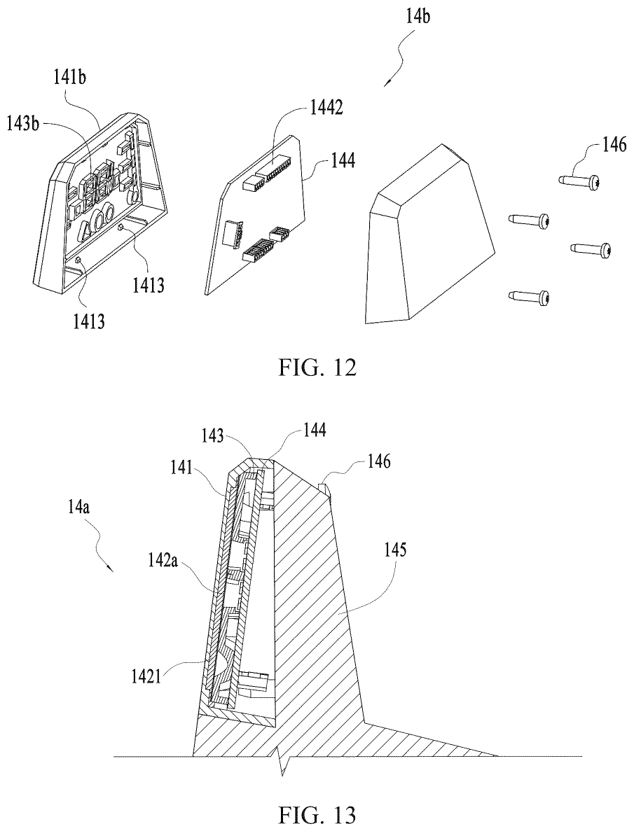

FIG. 12 is another example of the display 14 involved in the present application. Different from the preceding example, a light guide portion 143b is disposed on a second surface 1412 of the transparent cover 141, the light guide portion 143b is a part of the transparent cover 141, and the light guide portion 143b and the transparent cover 141 are integrally formed during the manufacturing process. In an example, the image portion 142 is directly printed or engraved on a third surface 1411 of the transparent cover 141 instead of being pasted on the transparent cover 141 or the light guide portion 143 in the form of a film.

FIG. 13 is a side sectional view of the display 14 disclosed in FIGS. 9 and 10. In an example, a colloid 1421 may exist between the transparent cover 141 and the image film 142a, and the colloid 1421 basically fills the gap between the transparent cover 141 and the image film 142a so that the air in the gap is squeezed out, preventing the following: fogging caused by high air humidity makes it difficult for the user to see the displayed content of the display 14 clearly. In addition, the colloid 1421 may be used as a fixing method to fix the image film 142a on the transparent cover 141.

FIG. 14 shows a telescopic rod structure 200, specifically, a length-adjustable telescopic rod structure 200. The telescopic rod structure 200 may be applied in the walk-behind working machine, and the walk-behind working machine may be a working machine such as a mower 201 (see FIG. 29) or a snow thrower that can work in grasslands, snowfields, and other environments and has a pushable function.

As shown in FIG. 14, the walk-behind working machine has the telescopic rod structure 200, and the telescopic rod structure 200 includes a grip device 24, a telescopic rod assembly 20, and a locking device 23. The grip device 24 may be held by the user so that the user can operate the walk-behind working machine. The telescopic rod assembly 20 includes a first telescopic rod assembly 21 and a second telescopic rod assembly 22, where the first telescopic rod assembly 21 is basically parallel to the second telescopic rod assembly 22. The locking device 23 is used for adjusting the length of the telescopic rod assembly 20. The telescopic rod structure 200 in FIG. 14 further includes a spring hose 26, and the internal accommodation space may be used for accommodating circuit elements such as electric wires, which is more convenient for the walk-behind working machine controlled by electricity.

FIG. 15 shows the specific structure after the first telescopic rod assembly 21, the second telescopic rod assembly 22, and the locking device 23 are disassembled. The basic principles of the first telescopic rod assembly 21 and the second telescopic rod assembly 22 are the same, and the first telescopic rod assembly 21 is used as an example for the detailed description. The first telescopic rod assembly 21 includes a first rod 211 and a first rod 212, where the first rod 211 and the first rod 212 have different inner diameters so that the first rod 211 and the first rod 212 can be sleeved together. In this example, the inner diameter of the first rod 211 is less than the inner diameter of the first rod 212 so that the first rod 211 protrudes into the first rod 212.

The locking device 23 includes a locking rod 231, an operating member 232, and a locking assembly 230. The locking assembly 230 is further divided into a first locking assembly 233 and a second locking assembly 234. The locking rod 231 connects the first locking assembly 233 to the second locking assembly 234, and the first locking assembly 233 and the second locking assembly 234 are located at two ends of the locking rod 231. A second cover 235 and a second cover 236 provide an accommodation space to limit the locking rod 231, the operating member 232, the locking assembly 230, the first telescopic rod assembly 21, and the second telescopic rod assembly 22 in a fixed space. The principles of the first locking assembly 233 and the second locking assembly 234 are the same. The first locking assembly 233 and the second locking assembly 234 are connected by the locking rod 231 and separately located at two ends of the locking rod 231. Now, the first locking assembly 233 is used as an example for describing the specific structure and principle.

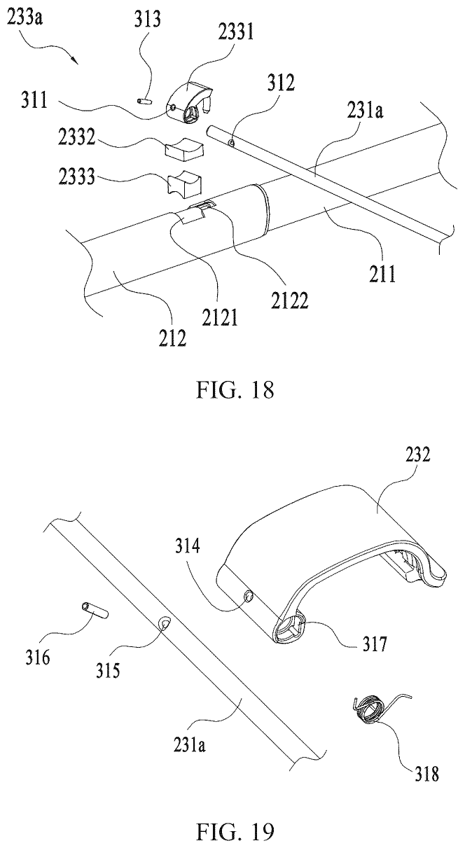

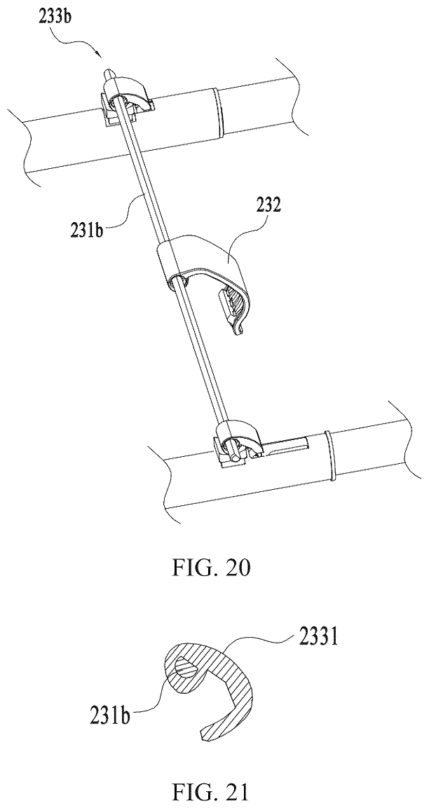

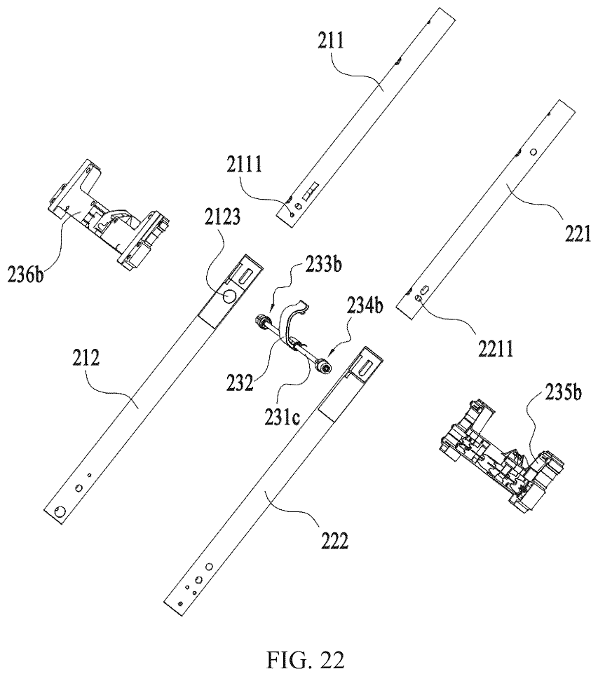

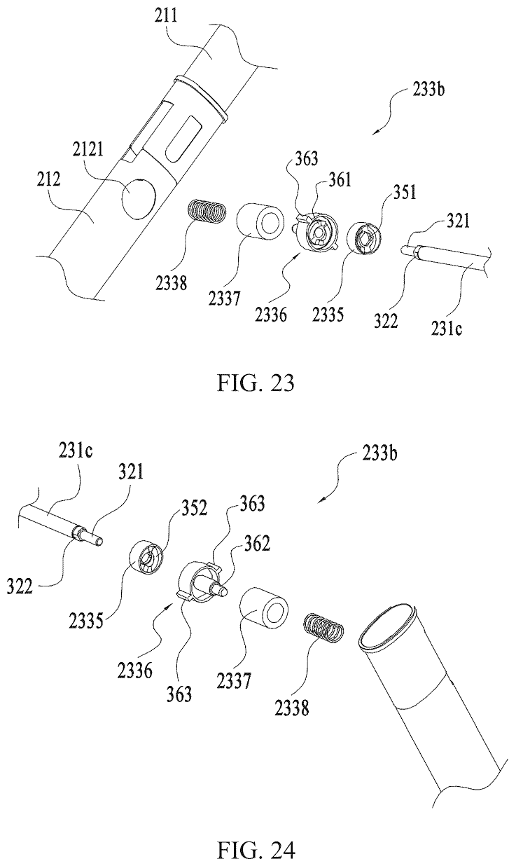

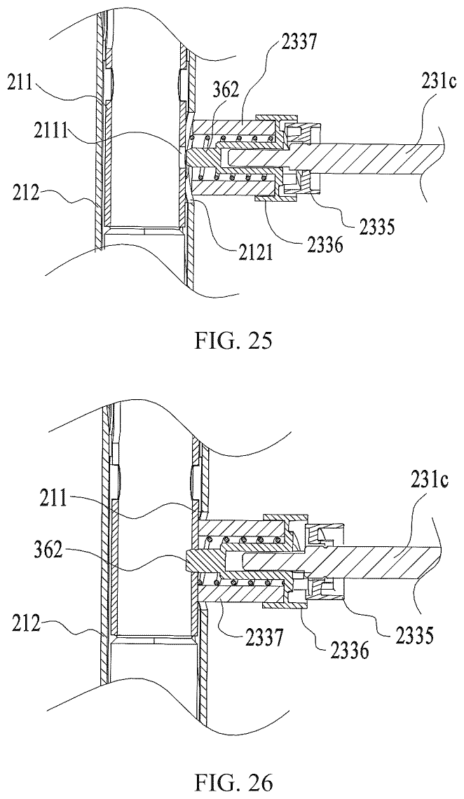

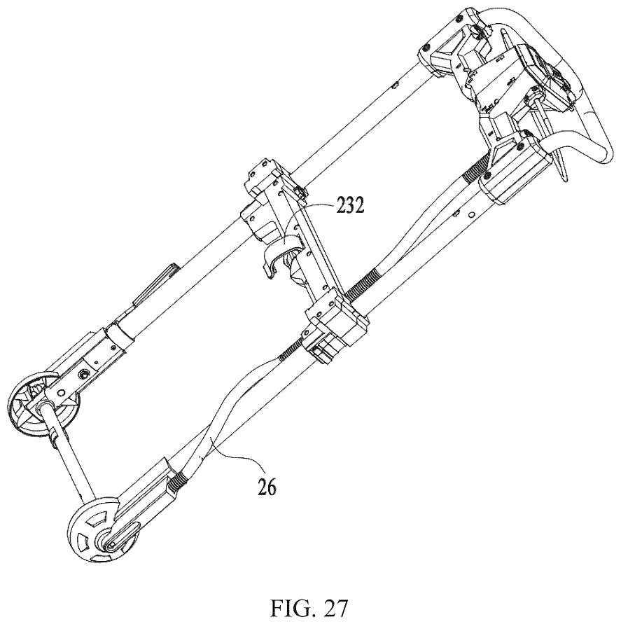

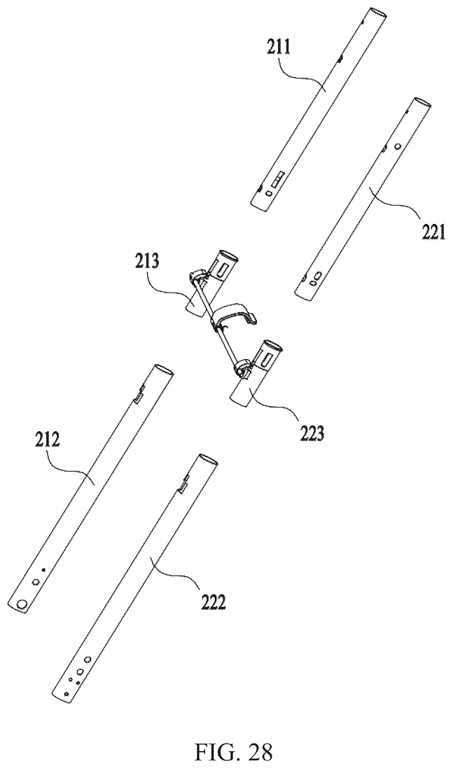

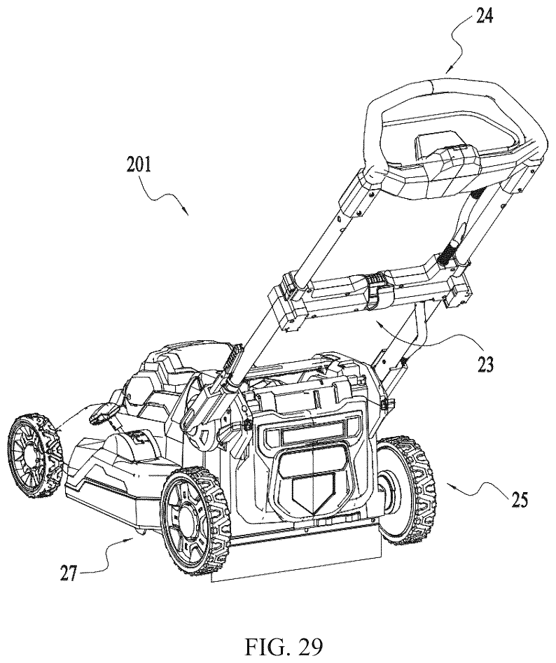

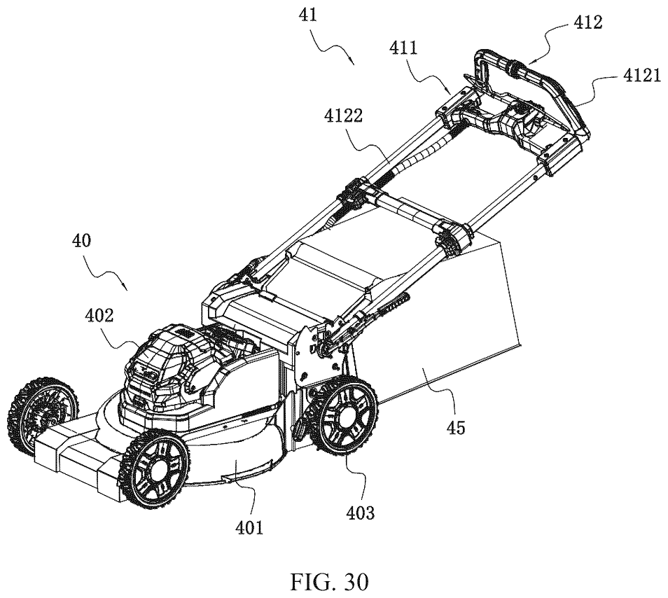

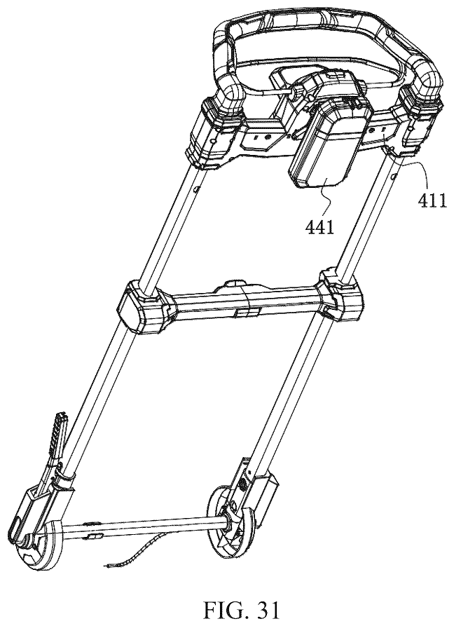

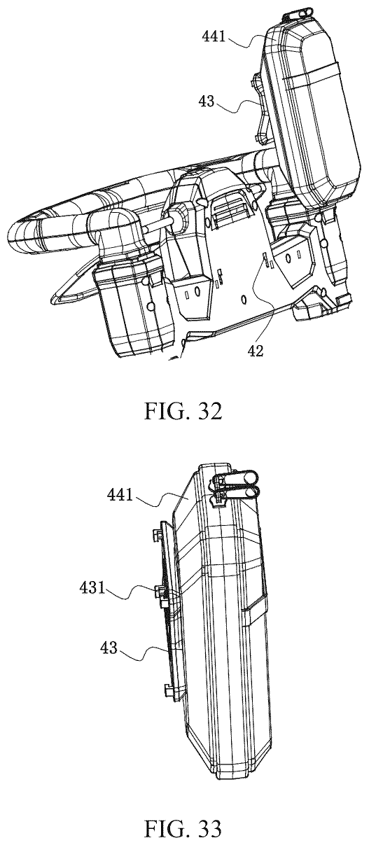

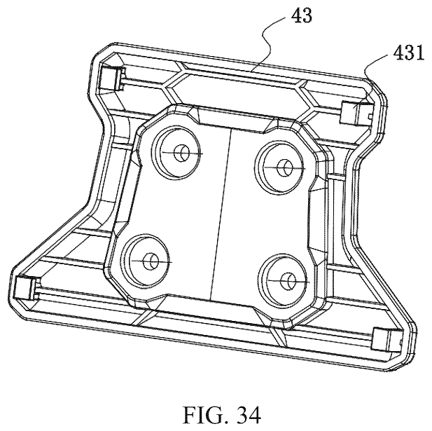

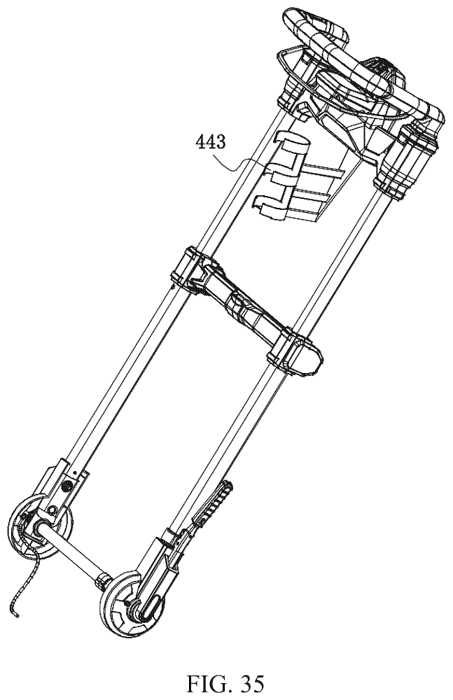

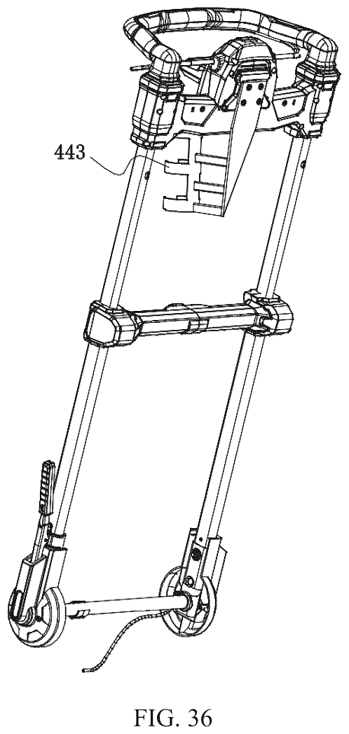

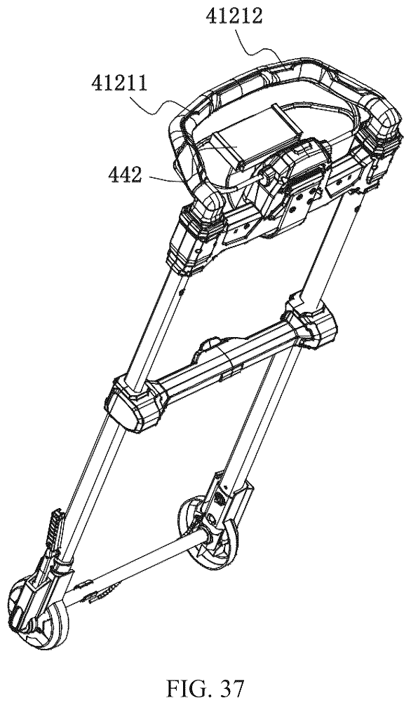

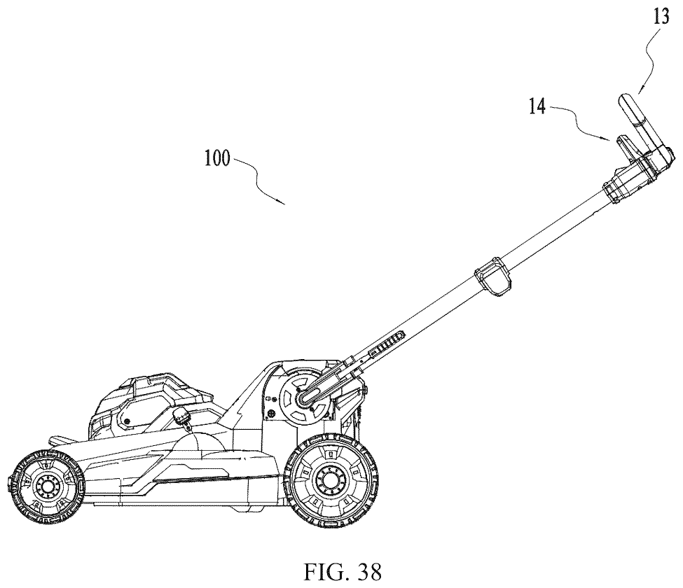

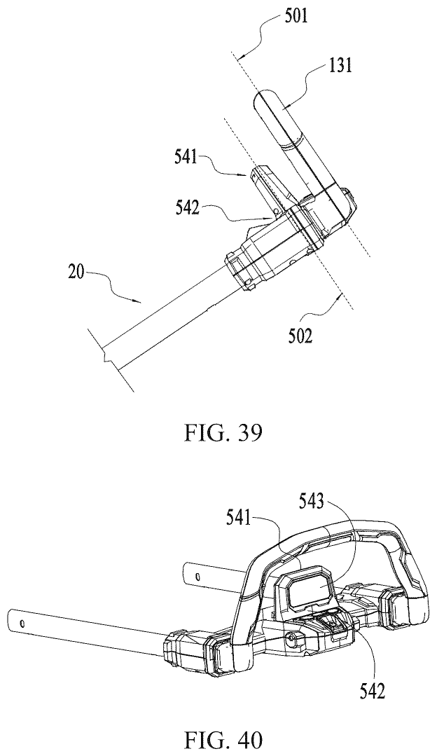

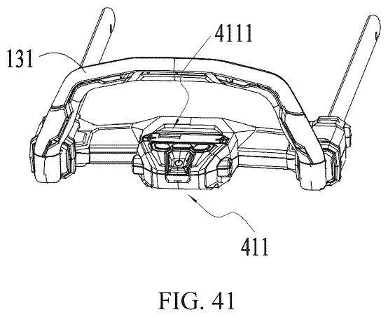

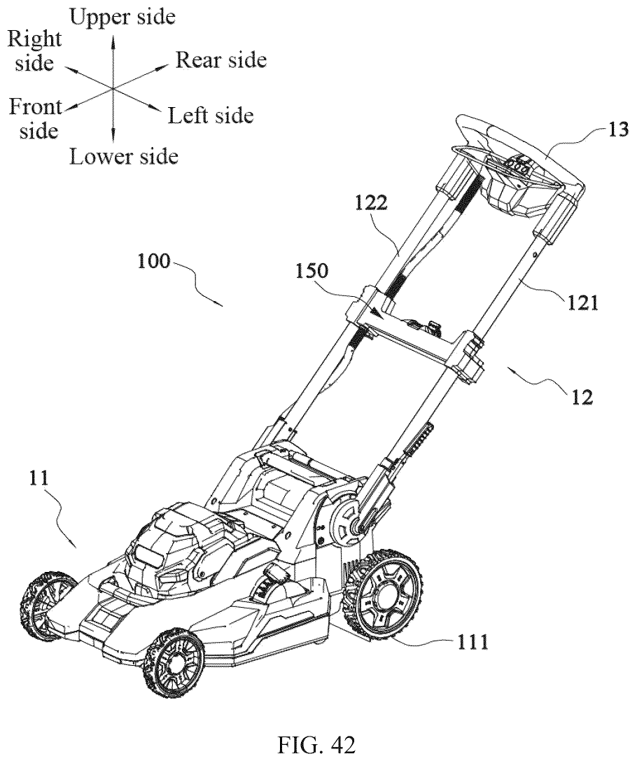

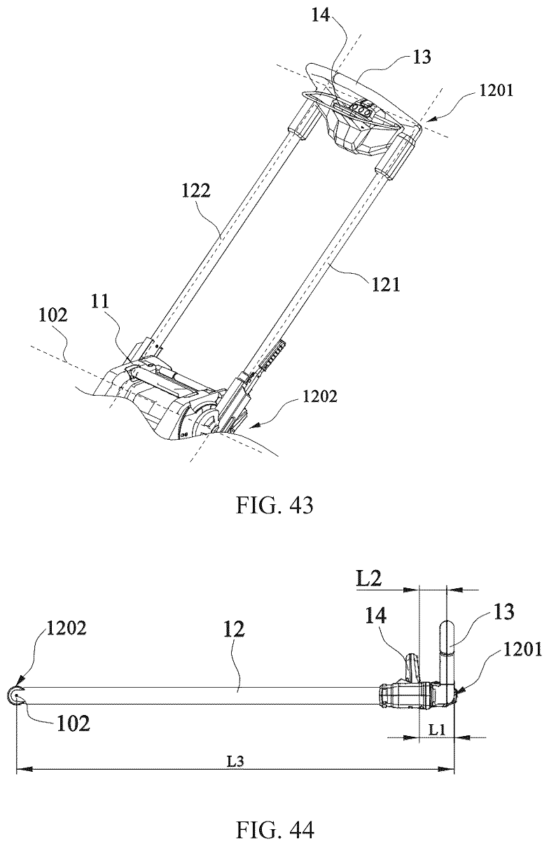

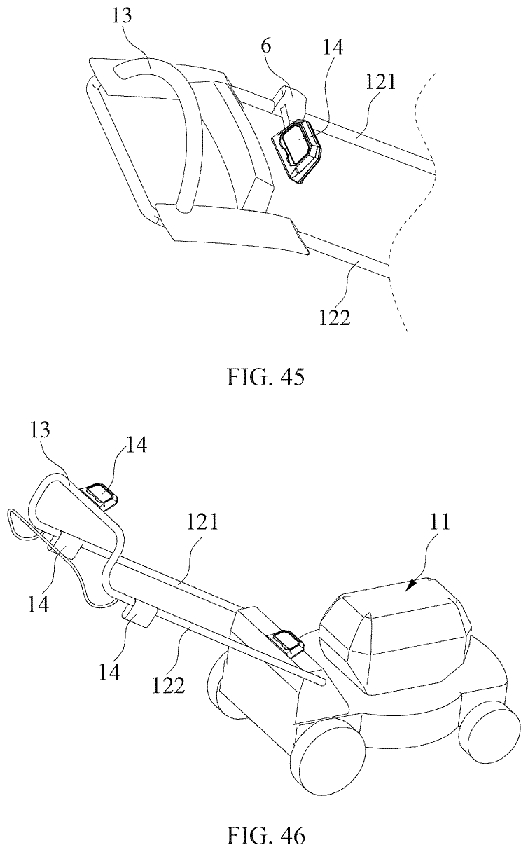

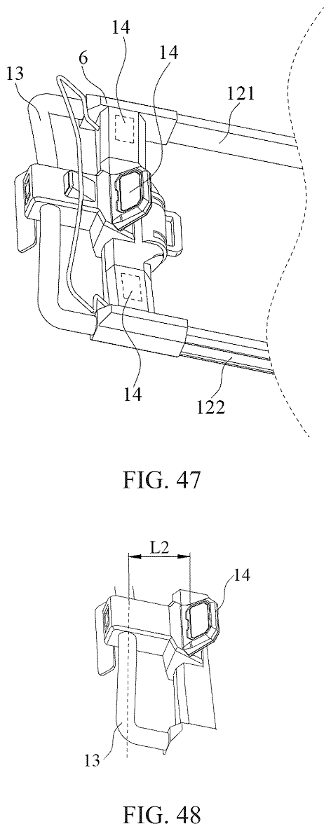

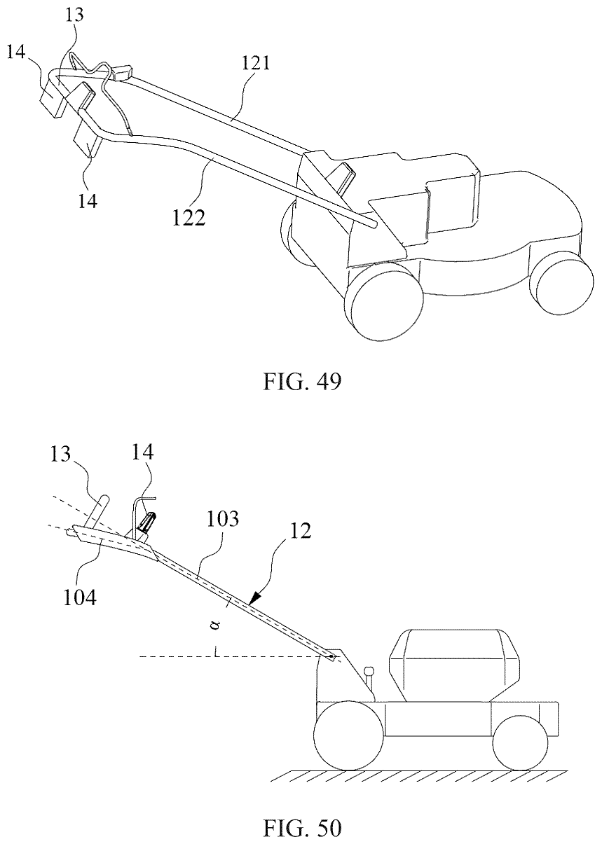

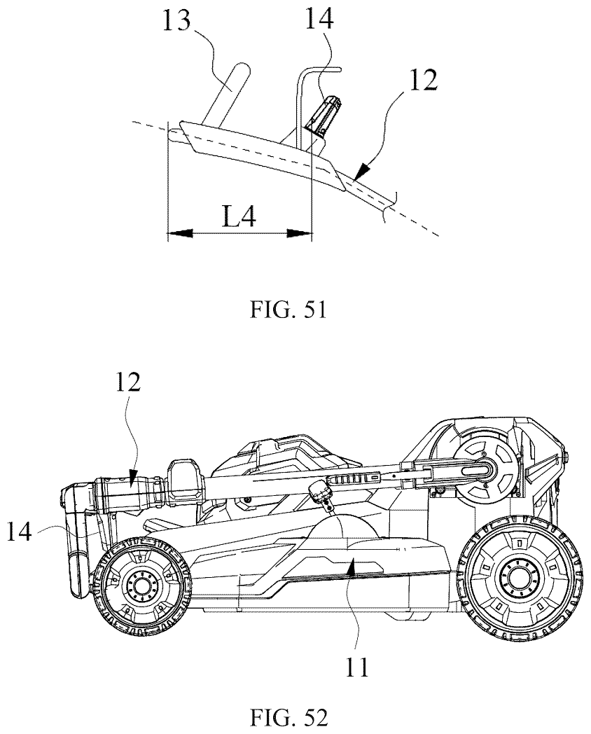

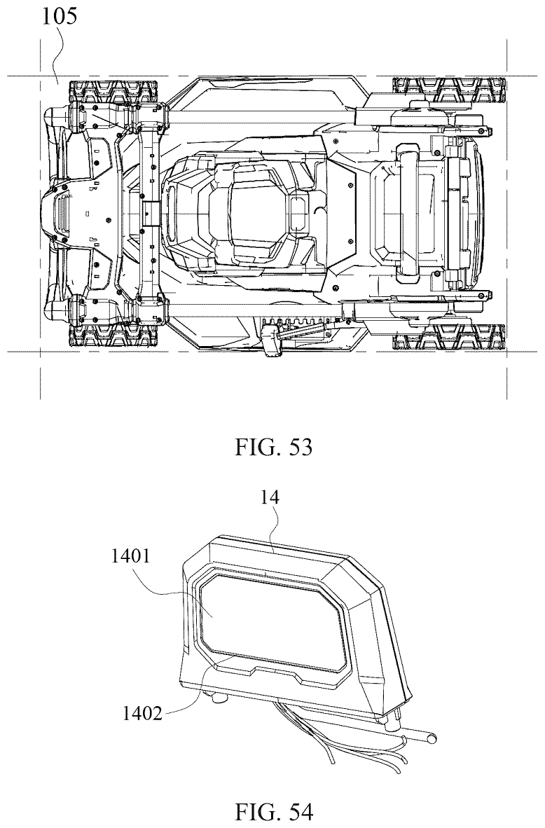

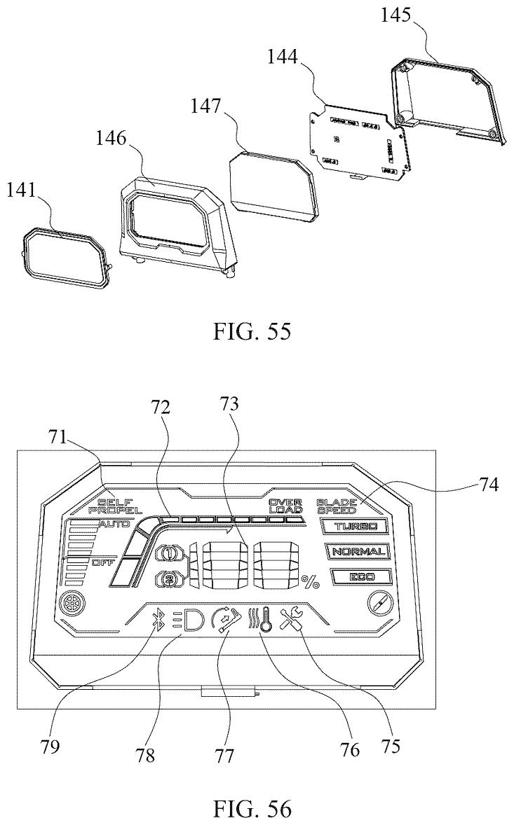

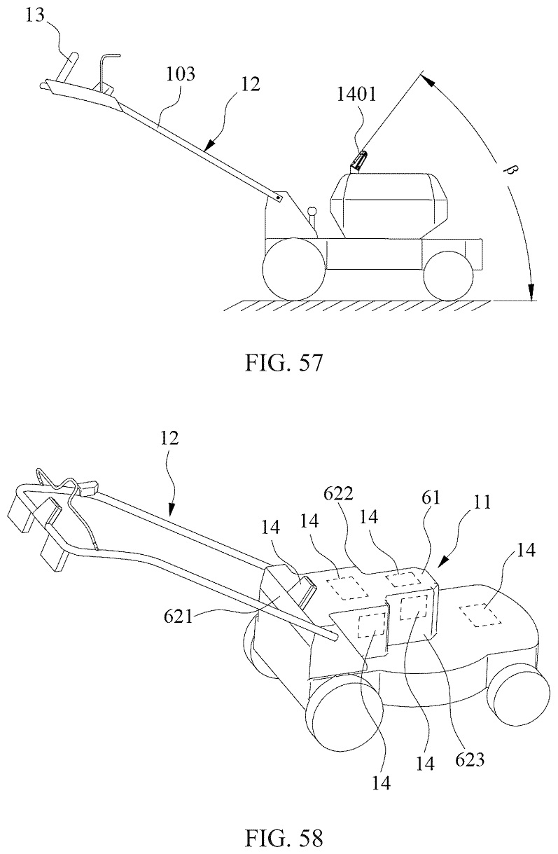

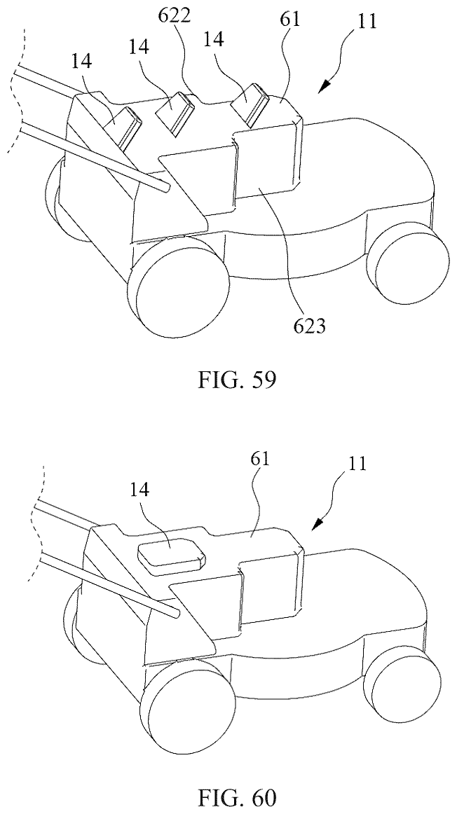

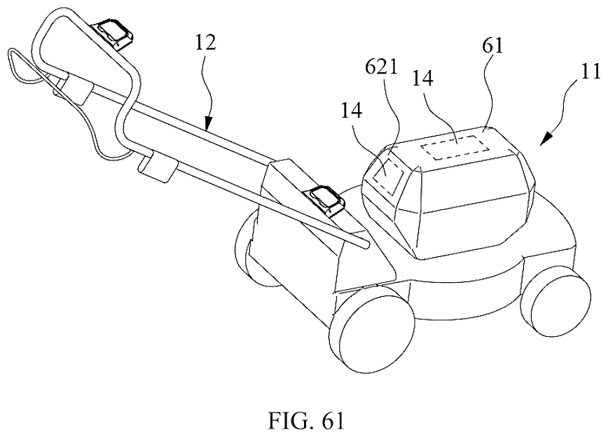

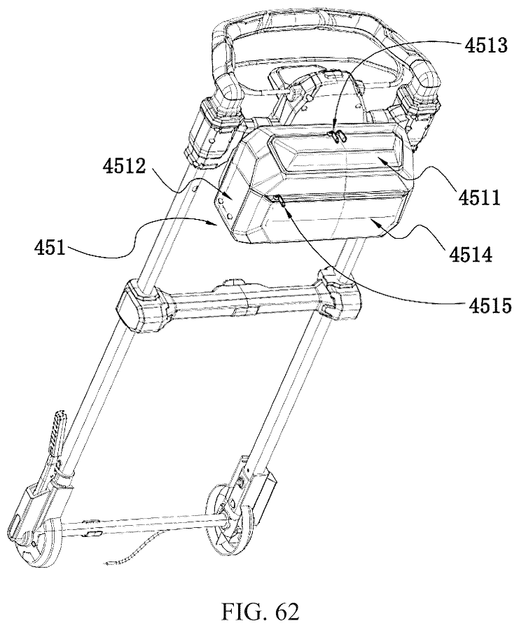

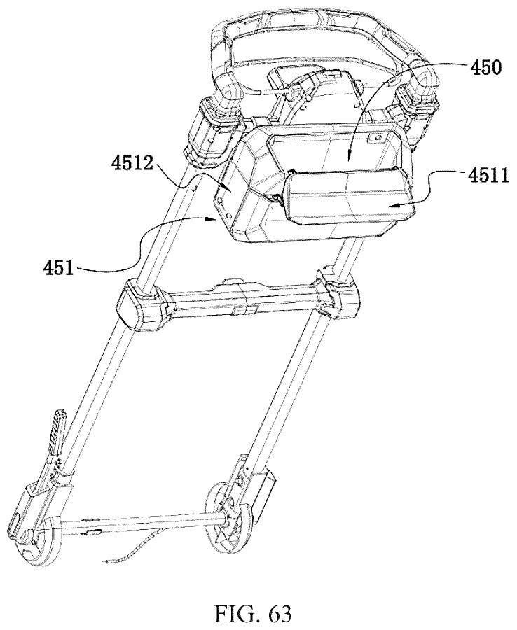

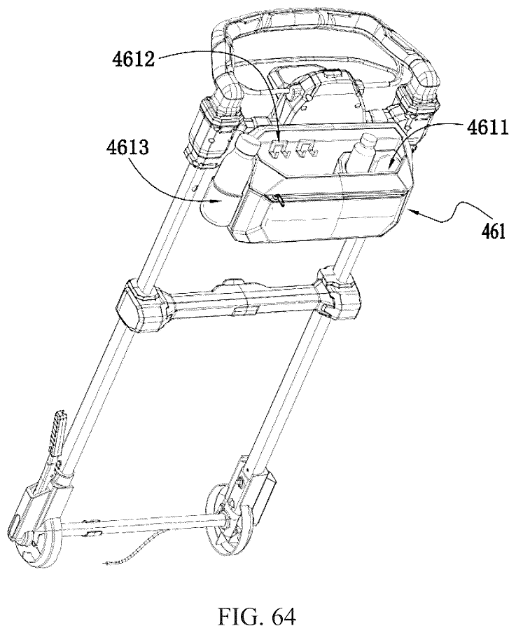

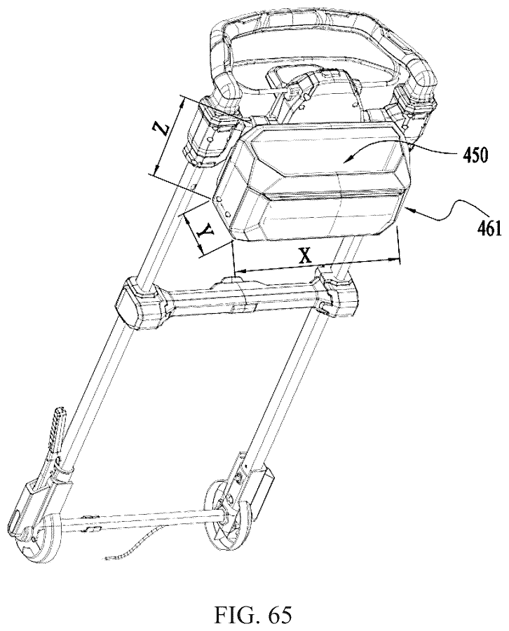

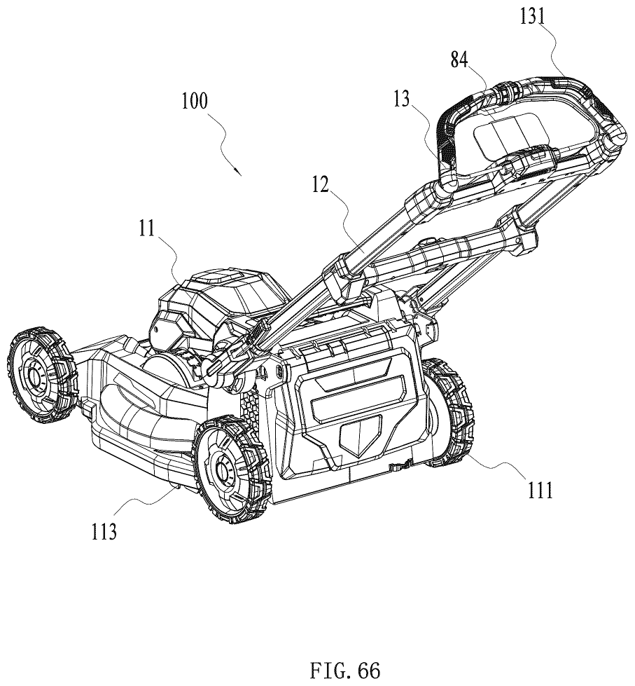

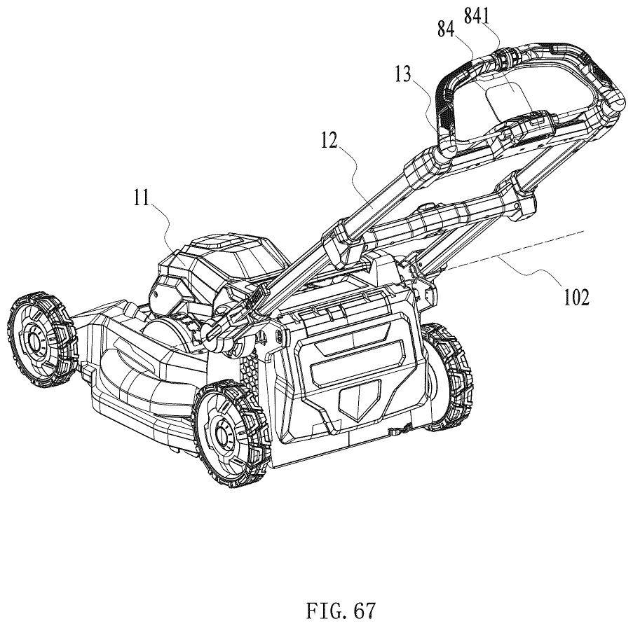

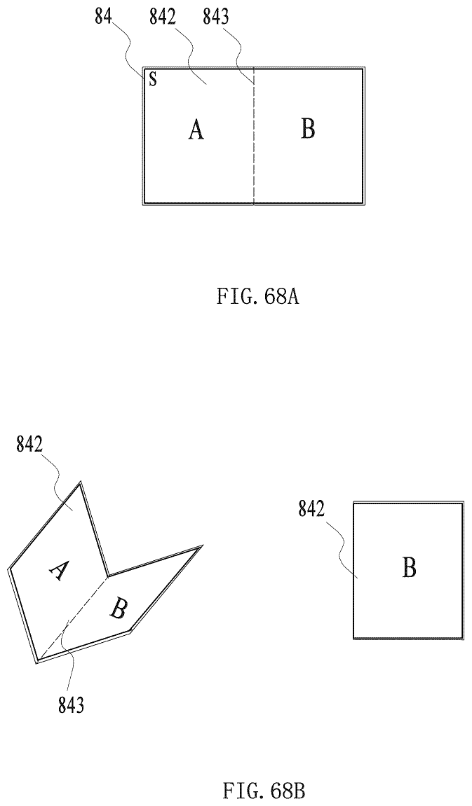

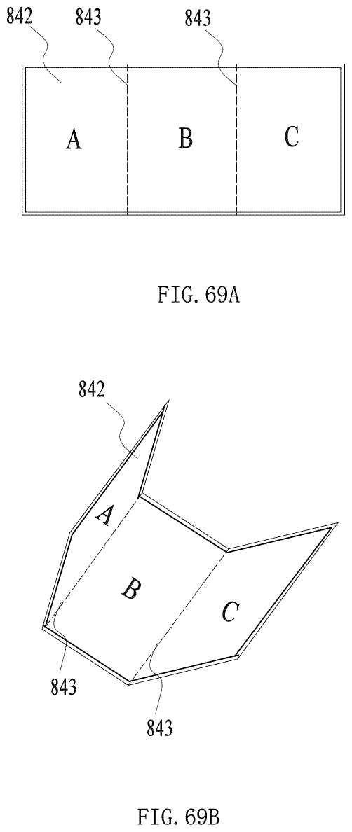

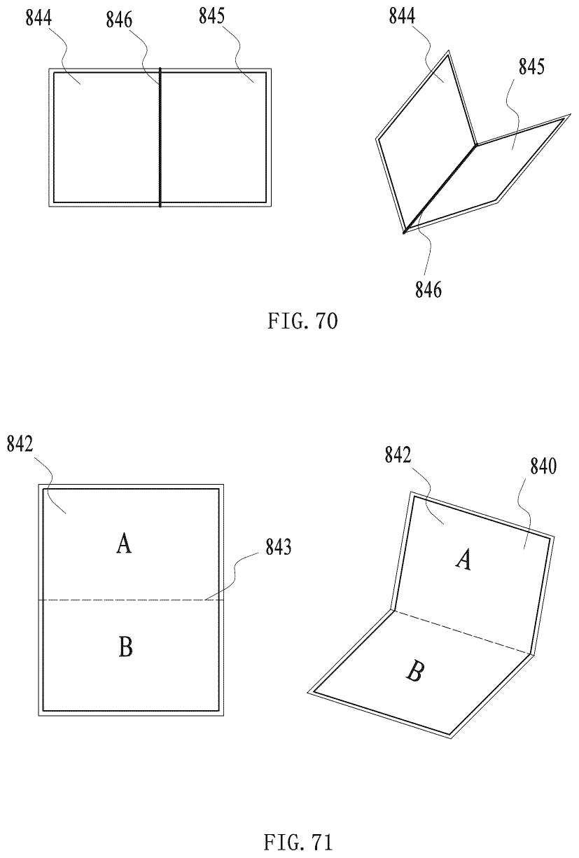

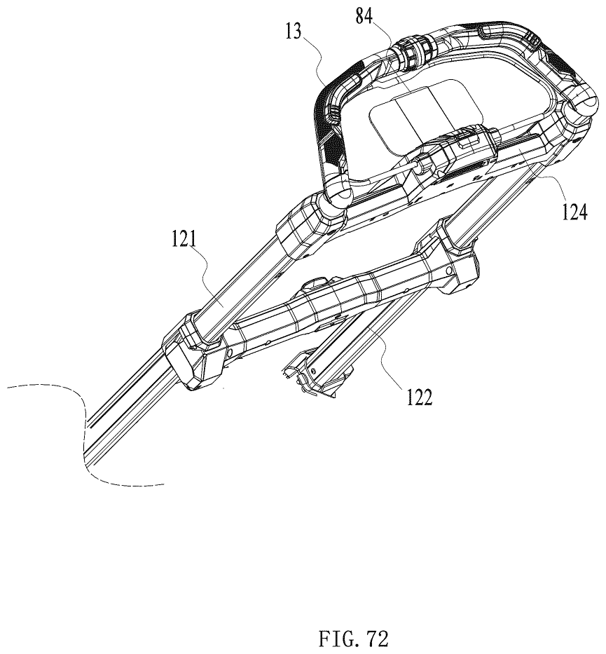

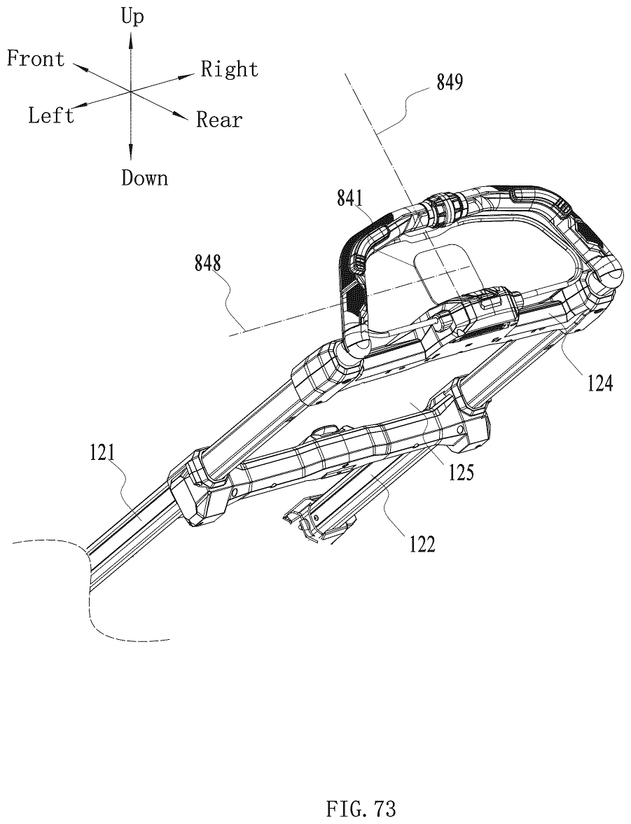

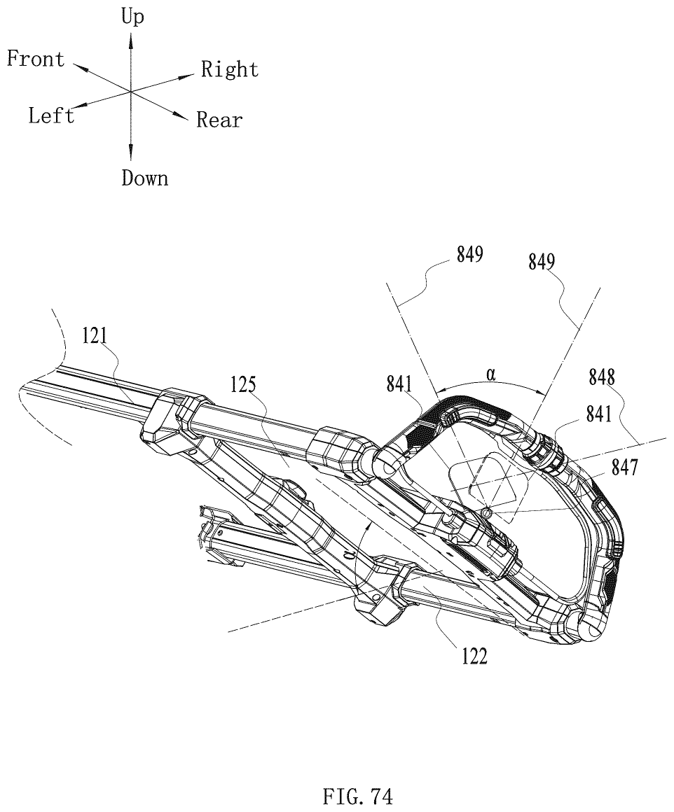

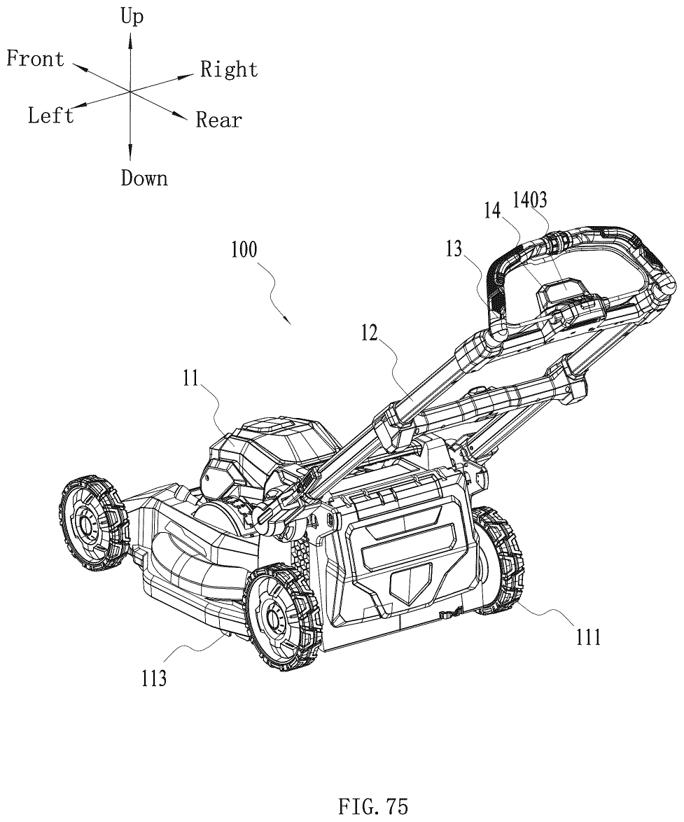

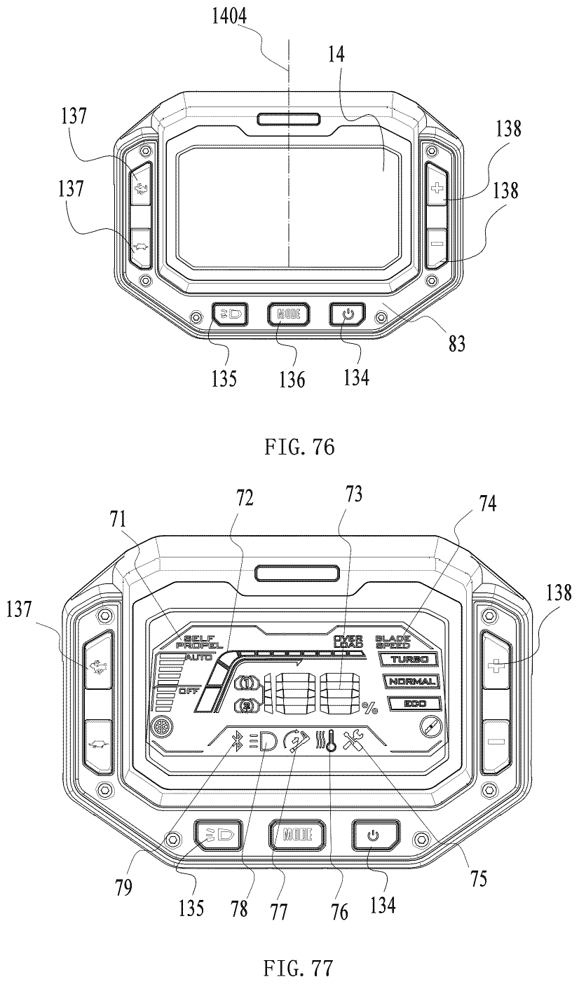

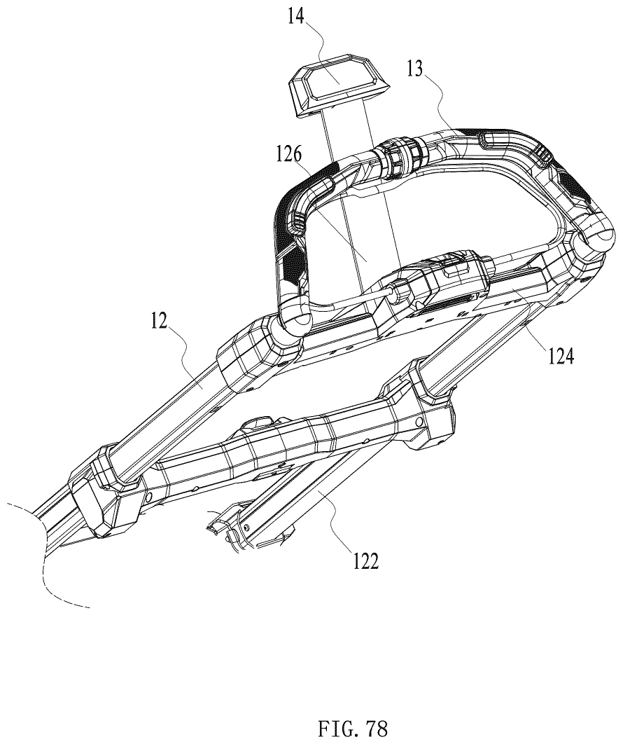

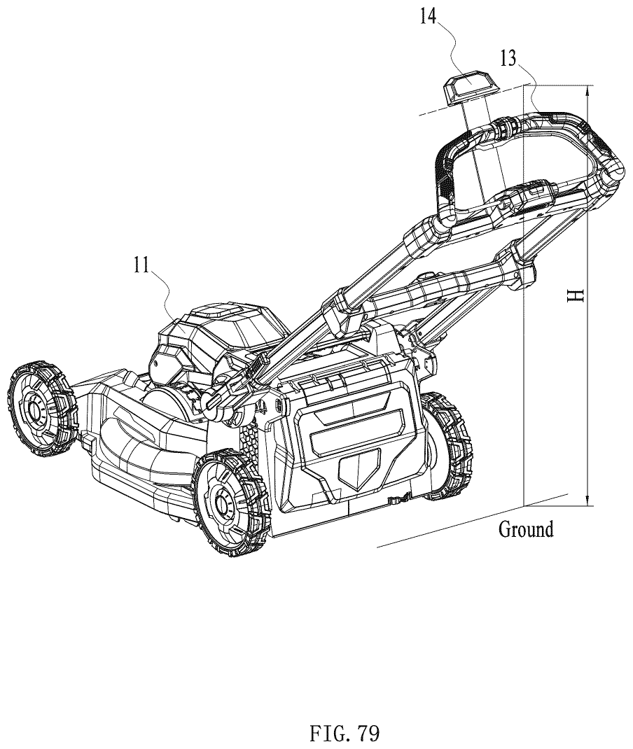

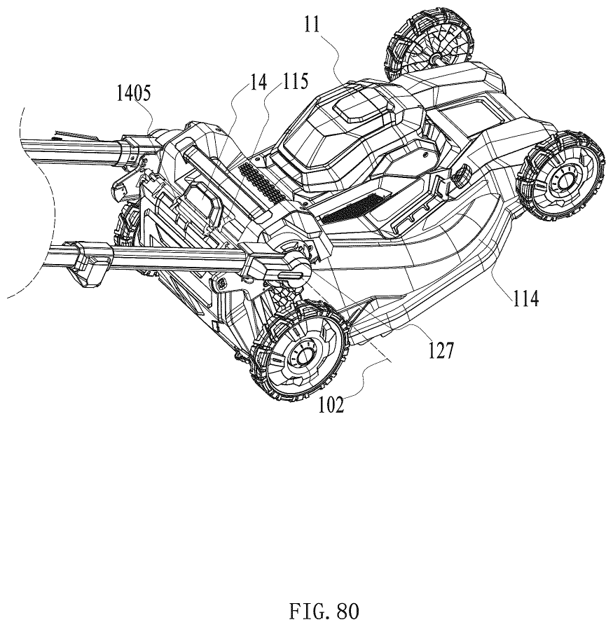

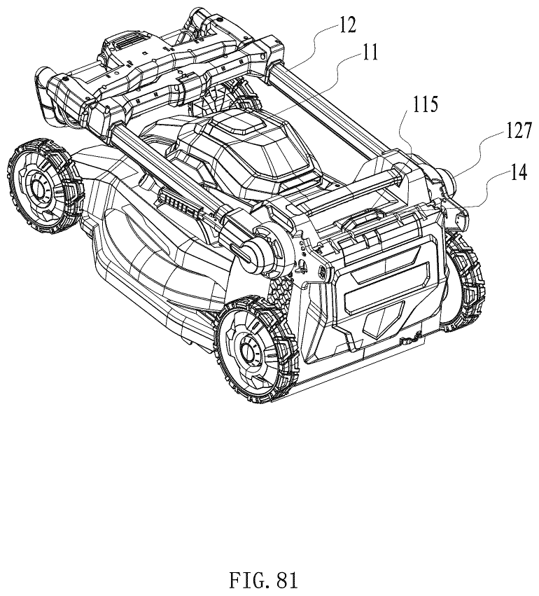

FIGS. 16 to 19 are specific technical solutions of the telescopic rod structure 200 as the first example. A first locking assembly 233a includes a first rotary member 2331, a rigid member 2332, and a first elastic member 2333. A pin 313 (see FIG. 18) penetrates a first opening 311 of the first rotary member 2331 and a second opening 312 of a locking rod 231a at the same time, thereby fixing the first rotary member 2331 and the locking rod 231a and ensuring that the first rotary member 2331 rotates synchronously with the locking rod 231a when the locking rod 231a rotates. The first rotary member 2331 further includes a first extension portion 310 (see FIG. 16). When the first rotary member 2331 rotates, the first extension portion 310 rotates synchronously with the first rotary member 2331. As shown in FIG. 17, the first rod 212 includes a hole 2122, and the hole 2122 has a diameter large enough for the first extension portion 310 of the first rotary member 2331 to penetrate the hole 2122. The first rod 212 further includes a first groove 2121, and the first elastic member 2333 penetrates the first groove 2121 and is in contact with the first rod 211. When the first elastic member 2333 is compressed, the first elastic member 2333 presses the first rod 211 and prevents the first rod 211 from moving along the axial direction of the first rod 211.

As shown in FIG. 16, the locking assembly 233a is in a first state, the first elastic member 2332 is released, and the first extension portion 310 of the first rotary member 2331 is located outside the hole 2122 of the first rod 212. At this time, the first rod 211 and the first rod 212 are telescopic along the up and down direction, that is, in this state, the length of the first telescopic rod assembly 21 is adjustable.

As shown in FIG. 17, the first rotary member 2331 includes a cam surface, the cam surface is in contact with the rigid member 2332, and the first elastic member 2333 is located below the rigid member 2332. When the locking assembly 233a is in a second state, the first elastic member 2333 is pressed by the rigid member 2332 so that the thickness of the first elastic member 2333 becomes smaller. In conjunction with FIG. 18, the frictional resistance generated when the first elastic member 2333 is pressed prevents the first rod 211 from further extending into the first rod 212; and the first extension portion 310 of the first rotary member 2331 is located inside the hole 2122 of the first rod 212, so as to lock the relative position between the first rod 211 and the first rod 212. At this time, the first rod 211 and the first rod 212 are locked along the axial direction of the first telescopic rod assembly 21 through the first extension portion 310, that is, in this state, the length of the first telescopic rod assembly 21 is fixed.

It is to be noted that, in some examples, the first elastic member 2333 and the rigid member 2332 may be the same component, which is not limited here.

As shown in FIG. 19, a pin 316 penetrates a second opening 315 on the locking rod 231 and a third opening 314 on the operating member 232 at the same time, and a torsion spring 318 is located in an engagement groove 317 of the operating member 232. In another example of the locking rod 231 (see FIGS. 20 and 21), the section of the locking rod 231b on a plane perpendicular to the axis of the locking rod 231b is an irregular circular shape, and the operating member 232 and the locking rod 231 can be fixed without the need for a pin.

It is to be noted that no matter which example is used to connect the locking rod 231, the operating member 232, the first locking assembly 233, and the second locking assembly 234, the first locking assembly 233 and the second locking assembly 234 can be controlled through the rotation of the locking rod 231. That is to say, when the operating member 232 is operated, the first telescopic rod assembly 21 and the second telescopic rod assembly 22 are locked or released at the same time so that the user does not need to operate the locking assembly on a certain side separately to lock or release the telescopic rod structure 200. The locking rod 231 is provided and connects the first locking assembly 233 to the second locking assembly 234, and the locking assemblies on two sides are in the same state so that the unlocking or locking operation of the user is more stable and reliable and is less likely to fail.

FIGS. 22 to 26 show the internal structure of the telescopic rod structure 200 as the second example. The internal structure of a first locking assembly 233b is described below as an example.

As shown in FIGS. 23 and 24, the first locking assembly 233b includes a second rotary member 2335, a lock 2336, an elastic sleeve 2337, and a second elastic member 2338. A locking rod 231c includes a mating portion 322 and a second extension portion 321. The mating portion 322 mates with a first mating surface 351 of the second rotary member 2335. When the locking rod 231c rotates, the second rotary member 2335 rotates synchronously. The lock 2336 includes at least one limiting portion 363, and the limiting portion 363 is limited by one of the first cover 235 and the second cover 236 or both the first cover 235 and the second cover 236 so that the lock 2336 cannot rotate and can only move along the axial direction of the locking rod 231c. The second rotary member 2335 further includes a second mating surface 352. The second mating surface 352 mates with a third mating surface 361 of the lock 2336. When the second rotary member 2335 rotates, the lock 2336 is displaced along the axial direction of the locking rod 231c. Therefore, the rotation of the locking rod 231c causes the lock 2336 to enter or move out of the telescopic rod assembly 21.

Now focusing on FIGS. 25 and 26, the first locking assembly 233b in FIG. 25 is in the first state. At this time, a third extension portion 362 on the lock 2336 is located outside a fourth opening 2111 of the first rod 211, the second elastic member 2338 is released, the first rod 211 may extend downward into the first rod 212, and the elastic sleeve 2337 is separated from the outer wall of the first rod 211 and does not apply a friction to the first rod 211. That is, in this state, the length of the first telescopic rod assembly 21 is adjustable. The first locking assembly 233b in FIG. 26 is in the second state. At this time, the locking rod 231c rotates by a certain angle from the first state so that the distance between the second mating surface 352 of the second rotary member 2335 and the third mating surface 361 of the lock 2336 is reduced, while the axial position of the locking rod 231c remains unchanged. In this manner, the second extension portion 362 on the lock 2336 moves into the fourth opening 2111 of the first rod 211, and the first rod 211 cannot continue extending downward into the first rod 212. At the same time, the second elastic member 2338 is pressed, and the elastic sleeve 2337 fits the outer wall of the first rod 211 and applies a friction to the first rod 211, further preventing the first rod 211 from moving relative to the first rod 212. That is, in this state, the length of the first telescopic rod assembly 21 is fixed.

It is to be noted that, in some examples, the elastic sleeve 2337 may be used as a part of the lock 2336 and integrally formed with the lock 2336, which is not limited here.

FIG. 27 is another example of the operating member 232 that is different from that in FIG. 1. It is to be pointed out here that changes in the specific position and opening angle of the operating member 232 do not affect the effect of the present application and the design of changing the position of the operating member 232 without changing the implementation principle of the telescopic rod structure 200 falls within the scope of the present application.

Referring to FIG. 28, in some examples, the first rod 211, the first rod 212, and a first intermediate rod 213 may further be included, that is, a connecting rod is added between the first rod 211 and the first rod 212, but the implementation of the function is not affected.

The function of the first cover 235 and the second cover 236 is to provide a closed and stable space for the internal assembly. As shown in FIG. 15, a first end cover 2361 and a second end cover 2362 are additionally provided on the second cover 236 to facilitate the assembly of the first locking assembly 233 and the second locking assembly 234. Alternatively, as shown in FIG. 22, the second cover 236b and the first cover 235b are directly assembled, which is suitable for the case where the locking assembly 230 is easier to assemble. In addition, the forms of the cover plates are not limited to the first cover 235 and the second cover 236, and the cover plates may also be a left cover and a right cover along the axial direction of the locking rod 231 or a combination of the left cover, the right cover, and an intermediate cover. The forms of the cover plates are not limited here.

FIG. 29 shows a walk-behind working machine 201. The walk-behind working machine 201 includes the grip device 24, the telescopic rod assembly 20, the locking device 23, a walking assembly 25, a cutting assembly 27, and the motor (not shown in the figure). The grip device 24 is used for the user to hold. The telescopic rod assembly 20 includes the first telescopic rod assembly 21 and the second telescopic rod assembly 22. The walking assembly 25 and the grip device 24 are connected by the first telescopic rod assembly 21 and the second telescopic rod assembly 22. The cutting assembly 27 is used for completing a mowing operation. The motor is used for driving the cutting assembly 27 to perform the mowing operation. The specific technical features are stated above and not repeated here.

It is to be noted that the orientation of the view in FIG. 29 is different from the orientations shown in FIGS. 14 to 28, FIG. 29 shows the use angle of the telescopic rod in practical applications, and in practical applications, the positions of the locking device 23 and the operating member 232 on the telescopic rod structure 200 may be adjusted, which is not limited to the manner disclosed in the drawings of this specification. If the operating member 232 is an operating wrench, the wrenching direction and angle of the wrench may be changed with the change of the overall technical solution and finally serve an operator so that the operator has a good operating experience.

FIG. 30 shows a rear-traveling self-propelled working machine, which may specifically be a mower 400, a snow thrower, a trolley, or another working machine with a self-propelled function. As an optional example, the mower 400 is used as an example for description. Specifically, the mower 400 in this example is a push mower 400.

As shown in FIG. 30, the mower 400 mainly includes a body 40, an operating device 41, and a grass collecting device 45. The body 40 includes a working element for implementing the function of the walk-behind working machine. Specifically, the body 40 includes a chassis 401, a power mechanism 402, and a walking assembly 403, and the chassis 401 serves as the main support structure of the mower 400 and assembles all parts into one. The walking assembly 403 is mounted on the chassis 401 and used for supporting the chassis 401, and the walking assembly 403 rotates relative to the chassis 401 so that the chassis 401 moves on the ground. The walking assembly 403 may be wheels. The power mechanism 402 is mounted on the chassis 401 and used for driving the walking assembly 403 to rotate, thereby driving the mower 400 to move on the ground. The grass collecting device 45 is connected to the rear of the body 40 and used for collecting the cut weeds. The grass collecting device 45 may specifically be a grass collecting basket or a grass collecting box.

The operating device 41 is connected to the body 40 and used for the user to operate the mower 400 on the rear side of the mower 400. The operating device 41 in this example includes a switch box 411, and an electronic component for controlling the working state of the working element is disposed in the switch box 411.

As shown in FIGS. 31 and 32, the walk-behind working machine further includes a first mounting portion 42 disposed on the switch box 411 and a second mounting portion 43 detachably connected to the first mounting portion 42, where the second mounting portion 43 can be connected to or formed on different attachments. The walk-behind working machine can be attached with different attachments, has relatively high universal interchangeability, can satisfy different use requirements of the user, and improves user satisfaction.

As shown in FIGS. 31, 35, and 36, the attachments in this example include a storage box 441, a phone holder 442, a cup holder 443, an electric fan, and the like, and items such as a mobile phone and a key may be placed in the storage box 441.

In an example, with continued reference to FIG. 30, the operating device 41 further includes a handle 412 for the user to push the mower 400 to travel, and the switch box 411 is fixed to the handle 412. In this structure, the attachment is relatively close to the user and is convenient for the user to pick up and use.

Further, the handle 412 includes a grip 4121 and a connecting rod 4122. The grip 4121 is for the user to hold, so as to apply a force to push the mower 400. The connecting rod 4122 is a hollow long rod structure, and the connecting rod 4122 is used for connecting the grip 4121 to the body 40. Two connecting rods 4122 are provided side by side in the left and right direction, thereby improving the connection stability between the grip 4121 and the body 40. In this example, the grip 4121 at least partially extends along a direction of a first straight line, and the connecting rods 4122 extend along a direction of a second straight line perpendicular to the first straight line.

The grip 4121 is made of plastic material, which is convenient for forming and connecting with other parts, while the connecting rods 4122 are made of metal material to ensure the strength.

One end of the switch box 411 is fixed to the grip 4121, and the other end of the switch box 411 is fixed to the connecting rod 4122. The switch box 411 is used for accommodating an operating switch. The switch box 411 includes a switch box cover and a switch box seat, and the switch box cover and the switch box seat clamp the grip 4121 and the connecting rod 4122 from two sides.

In this example, the first mounting portion 42 and the second mounting portion 43 are connected in a snap-fit manner. The snap connection has a simple structure and is easy to implement and operate. Other detachable connection manners between the first mounting portion 42 and the second mounting portion 43 may be adopted, such as a threaded connection, a hinge connection, and a magnetic attraction connection, which may be designed according to actual conditions.

In an example, as shown in FIGS. 32 to 34, the first mounting portion 42 is a mounting hole opened on the switch box 411, and a snap 431 mating with the mounting hole is disposed on the second mounting portion 43. The snap 431 snaps into the mounting hole, so as to achieve the quick assembly and disassembly of the first mounting portion 42 and the second mounting portion 43. At least two snaps 431 and at least two mounting holes are provided to improve the connection stability. In this example, four snaps 431 and four mounting holes are separately provided.

Further, in an example, the first mounting portion 42 is the snap 431 disposed on the switch box 411, and a mounting hole mating with the snap 431 is disposed on the second mounting portion 43.

The second mounting portion 43 is a mounting plate, and the mounting plate and the first mounting portion 42 are connected in a snap-fit manner. The mounting plate is provided with the snap 431, and the snap 431 and the mounting hole are connected in a snap-fit manner.

The mounting plate and the attachment are detachably connected by screws so that different attachments can be replaced. The mounting plate is used as an intermediate connector. One end of the mounting plate is connected to the first mounting portion 42 on the switch box 411, and the other end of the mounting plate is connected to the attachment. The types of the attachments connected to the mounting plate may be replaced according to actual requirements, the attachments are interchangeable, more additional functions can be implemented, the versatility and adaptability are improved, and the diverse use requirements of the user can be satisfied. The mounting plate and the attachment may be connected in a detachable manner in which a hook is hooked to a hanging groove, as long as the quick disassembly and assembly between the mounting plate and the attachment can be achieved.

In this example, as shown in FIGS. 35 and 36, the grip 4121 includes a first grip 41211 for the left hand of the user to hold and a second grip 41212 for the right hand of the user to hold, where the first grip 41211 and the second grip 41212 are symmetrical about a symmetry plane. When the attachment is the phone holder 442, the phone holder 442 is located between the first grip 41211 and the second grip 41212. In this example, the first grip 41211 and the second grip 41212 are an integral structure. The grip 4121 may also be formed by connecting the first grip 41211 and the second grip 41212 that are independent of each other.

When the attachment is the phone holder 442, the phone holder 442 includes a first connecting plate and a bracket body. The first connecting plate is U-shaped, one end of the first connecting plate is connected to the mounting plate, and the other end of the first connecting plate bypasses the switch box 411 and is connected to the bracket body. The bracket body is used for clamping the mobile phone, and the bracket body is set upward and inclined toward the face of the user, so as to facilitate the operation and use of the user. The mobile phone communicates with the mower 400 to control the mower 400. Specifically, this function can be implemented through connection manners such as Bluetooth.

As shown in FIG. 36, when the attachment is the cup holder 443, the cup holder 443 is located between the two connecting rods 4122. Specifically, the cup holder 443 includes a second connecting plate and a bracket body. One end of the second connecting plate is connected to the mounting plate, and the other end of the second connecting plate is fixed with the bracket body. The bracket body is located below the switch box 411 and between the two connecting rods 4122, and the frame body is used for placing a water cup or a drink cup.

When the attachment is an electric fan, the base of the electric fan is connected to the mounting plate, and the electric fan is set toward the user so that the air can be blown to the user when the user uses the mower 400, thereby improving user comfort. It is to be understood that the electric fan referred to in this example is a small electric fan, such as a desk small electric fan and a small electric fan that can be clamped on the head of a bed.

The display 14 in FIG. 1 is further described below.

FIG. 38 is a side view of the mower 100 in FIG. 1, and FIG. 39 is a partial enlarged view of FIG. 38. As shown in FIG. 39, the grip 131 is basically symmetrical about a first middle plane 502, the first middle plane 501 is a plane perpendicular to a paper surface, and the first middle plane 502 extends along the left and right direction of the mower 100. The display 14 is basically symmetrical about a second middle plane 502, the second middle plane 502 is a plane perpendicular to the paper surface, and the second middle plane 502 extends along the left and right direction of the mower 100. Therefore, from the perspective of the side view of the mower 100, the grip 131 extends basically along the first middle plane 501, and the display 14 extends basically along the second middle plane 502. The first middle plane 501 is basically parallel to the second middle plane 502. Here, “basically” means that the included angle formed by the first middle plane 501 and the second middle plane 502 is less than or equal to 10 degrees.

The second middle plane 502 is basically perpendicular to the telescopic rod assembly 20. The telescopic rod assembly 20 is a telescopically adjustable rod and connects the body 11 to the handle device 13. The details are shown in the specification above.

As shown in FIG. 40, the display 14 includes a top 541 at the top end and a bottom 542 at the bottom end. The top 541 is located at the topmost end of the display 14, the top 541 is not directly connected to the grip 131, and the bottom 542 is not directly connected to the grip 131 either. The display 14 includes a display interface 543 for presenting information about the walk-behind working machine to the user. The display interface 543 may be made of LEDs, a liquid-crystal display (LCD), or other luminous materials. It is to be noted that the top 541 here may be understood as follows: when the display 14 is perpendicular to the horizontal plane, the top 541 of the display 14 is a housing, the housing surrounds the outside of the display interface 543, and the top 541 is located on the upper part of the display interface 543. In an example, the top 541 is located above the display 14. In an example, if the display interface 543 covers the upper half of the display 14, the top 541 is the upper part of the display interface 543.

As shown in FIG. 41, the switch box 411 is connected to two ends of the grip 131. The switch box 411 includes a mounting structure 4111, and the bottom 542 of the display 14 is mounted to the mounting structure 4111 of the switch box 411. The display 14 may be mechanically and electrically connected to the switch box 411 through the mounting structure 4111, a control assembly is disposed in the switch box 411, and the control assembly is electrically connected to the display interface 543 of the display 14. The display 14 is detachably mounted to the mounting structure 4111 of the handle device 13.

In an example, the display 14 is non-rotatably fixed in the mounting structure 4111.

In an example, the top 541 of the display 14 is rotatable about the bottom 542, and the included angle formed by the first middle plane 501 and the second middle plane 502 is less than or equal to 45 degrees. In some examples, the included angle formed by the first middle plane 501 and the second middle plane 502 may be 15 degrees, 30 degrees, or 45 degrees.

Now, referring to FIG. 4, in an example, viewing the display 14 from a direction perpendicular to the display interface 543 of the display 14, only one side of the display 14 is connected to the handle device 13. In an example, only one side of the display 14 is connected to the switch box 411.

The display 14 viewed from the direction perpendicular to the display interface of the display 14 has at least an upper boundary 551 and a lower boundary 552, where the upper boundary 551 is basically parallel to the lower boundary 552, and the lower boundary 552 is connected to the switch box 411. In an example, the upper boundary 551 of the display 14 may be connected to the grip 131 so that the lower boundary 552 of the display 14 is suspended, and the control assembly is connected to the switch box 411 through the wire in the grip 131.

According to the technical solution disclosed in the present application, one side of the display 14 is directly connected to the handle device 13, and the other side of the display 14 is not connected to the handle device 13 so that the display 14 may be configured to be a slidable, detachable, and rotatable structure, thereby improving the practicability of the display 14. In the first aspect, the rotatable display 14 satisfies the observation requirements of more users; in the second aspect, the detachable display 14 facilitates the replacement of attachments, for example, replacing the display 14 with the phone holder 442, to implement more functions; in the third aspect, when the power of the mower 100 is insufficient, the user may choose to remove the display 14 to save power.

It is to be emphasized that the technical solutions involved in the present application can be applied not only to the mower but also to other pushable working machines such as the snow thrower.

FIGS. 42 to 61 show more examples of the display 14 of the walk-behind working machine. FIG. 42 shows a walk-behind mower, which is a working machine that can work in garden environments such as grasslands and has a pushable function. It is to be noted that the walk-behind mower does not necessarily have to rely on the thrust of the user to move.

As shown in FIG. 42, the mower 100 mainly includes the body 11, a holding handle 13, and the connecting rod assembly 12. The body 11 includes the walking assembly 111 and the drive assembly (not shown in the figure) for driving the walking assembly 111 to travel. The body 11 is further provided with cutting blades and a cutting drive assembly for driving the cutting blades to work (the cutting blades and the cutting drive assembly are not shown in the figure). The connecting rod assembly 12 connects the body 11 to the holding handle 13, and the connecting rod assembly 12 is pivotally connected to the body 11 around a pivot axis 102. The connecting rod assembly 12 can be folded above the body 11 for easy storage. In this example, the walking assembly 111 is a wheel assembly.

It is to be noted that the holding handle 13 is used for the user to hold. For some mowers 100, the switch box is provided at the place connected to the holding handle 13, and the control assembly for controlling the operation of the mower 100 is disposed in the switch box. In this case, even though the switch box is connected to the mower 100, the switch box is not used for the user to hold, so the switch box does not belong to the holding handle 13.

As shown in FIGS. 43 and 44, the connecting rod assembly 12 includes a first end 1201, the first end 1201 is an end of the connecting rod assembly 12 facing away from the body 11, an end of the connecting rod assembly 12 opposite to the first end 1201 is a second end 1202, and the second end 1202 is pivotally connected to the body 11 around the pivot axis 102.

To put it another way, in the extension direction of the connecting rod assembly 12, an end of the mower 100 facing away from the body 11 is the first end 1201, and an end of the mower 100 facing the body 11 is the second end 1202. That is to say, the connecting rod assembly 12 includes both the connecting rod and a housing enclosing the connecting rod, and the connecting rod assembly 12 is not defined solely by the telescopic part.

In an example, the walk-behind mower further includes the display 14, the display 14 includes an electronic display screen 1401, the display 14 is disposed between the holding handle 13 and the pivot axis 102, and the distance L1 between the first end 1201 of the connecting rod assembly 12 and a lower boundary 1402 of the electronic display screen 1401 of the display 14 is greater than 70 mm. In some examples, the distance L2 between the centerline of the holding handle 13 and the lower boundary 1402 of the electronic display screen 1401 of the display 14 is greater than 50 mm. The advantage of this arrangement is that the user's grip on the holding handle 13 is not affected, and the electronic display screen 1401 of the display 14 is not blocked when the user holds the holding handle 13, which is convenient for the user to view and operate the display 14 and less prone to the accidental touch or misuse.

In some examples, the distance between the first end 1201 of the connecting rod assembly 12 and the pivot axis 102 is L3, where L1/L3>0.1. The distance between the display 14 and the first end 1201 is properly set such that the display 14 is not blocked when the user holds the holding handle 13, which is convenient for the user to view and operate the display 14.

As shown in FIG. 45, in another example, the display 14 is disposed on the connecting rod assembly 12, and the connecting rod assembly 12 provides an installation carrier for the installation of the display 14. Alternatively, a mounting portion 6 for mounting the display 14 is disposed on the connecting rod assembly 12, thereby facilitating the installation of the display 14. In this solution, the distance between the display 14 and the holding handle 13 is not limited for the reason that when the display 14 is disposed on the connecting rod assembly 12, the relative position between the display 14 and the holding handle 13 does not necessarily affect the operation on the display 14 by the user. The display 14 may be disposed on a side of the holding handle 13 closer to the first end 1201 and may also be close to the position of the holding handle 13 viewed in the left and right direction, and the display 14 may be rotated so as to avoid the interference with the user operating the holding handle 13.

In some examples, the display 14 is detachable, at least two installation positions for setting the display 14 may be provided between the holding handle 13 and the pivot axis 102, and the user may change the position of the display 14 according to use requirements. For example, two installation positions may be set on the preceding connecting rod assembly 12, one mounting portion 6 may be disposed at each installation position, and the display 14 can be detachably connected to different mounting portions 6.

In some examples, with continued reference to FIG. 45, the connecting rod assembly 12 includes a first connecting rod 121, and the first connecting rod 121 connects the body 11 to the holding handle 13, that is, the first end 1201 of the first connecting rod 121 is an end facing away from the body 11, and the second end 1202 of the first connecting rod 121 is pivotally connected to the body 11 around the pivot axis 102.

The display 14 is detachably disposed on the first connecting rod 121 so that the user can take off the display 14 for operation, thereby improving the flexibility of the operation of the display 14. Alternatively, the display 14 is rotatably disposed on the first connecting rod 121 so that the user can adjust the angle of the display 14 according to factors such as the surrounding environment and the height of the user to view the content displayed on the display 14 more clearly or operate the display 14, and the display 14 is convenient to store when the first connecting rod 121 needs to be folded. Alternatively, the display 14 is detachably and rotatably disposed on the first connecting rod 121 so that the user can take off the display 14 for operation, improving the flexibility of the operation of the display 14, and the user can adjust the angle of the display 14 according to factors such as the surrounding environment and the height of the user to view the content displayed on the display 14 more clearly or operate the display 14.

If the display 14 is detachably disposed on the first connecting rod 121, at least two installation positions for mounting the display 14 may be disposed on the first connecting rod 121 or at least two mounting portions 6 for mounting the display 14 may be disposed on the first connecting rod 121, and the display 14 is rotatable or non-rotatable.

In some examples, the mounting portion 6 is disposed on the first connecting rod 121, the mounting portion 6 may include a fixed seat, a connecting portion is disposed on the fixed seat, the connecting portion may include a rotating shaft and a mounting seat, an end of the rotating shaft is fixedly or rotatably connected to the fixed seat, the axis of the rotating shaft is approximately perpendicular to the first connecting rod 121, the mounting seat is fixedly connected to the other end of the rotating shaft, and the display 14 is fixedly or detachably disposed on the mounting seat. The angle of the mounting seat may be adjusted by rotating the rotating shaft, thereby adjusting the angle of the display 14. If the display 14 is detachably connected to the mounting seat, the display 14 and the mounting seat may be connected through the snaps, screws, insertion fit, or magnetic attraction so that the display 14 is convenient to mount and disassemble.

It is to be noted that the connecting rod assembly 12 may include only one connecting rod, may also include two connecting rods (that is, the first connecting rod 121 and a second connecting rod 122), and may also include three or more connecting rods. The number of connecting rods does not affect the installation of the display 14. In this example, the display 14 may be mounted on any connecting rod of the connecting rod assembly 12.

As shown in FIG. 46, the connecting rod assembly 12 further includes the second connecting rod 122, and the second connecting rod 122 connects the body 11 to the holding handle 13, that is, the first end 1201 of the second connecting rod 122 is an end facing away from the body 11, and the second end 1202 of the second connecting rod 122 is pivotally connected to the body 11 around the pivot axis 102.

The display 14 is detachably disposed on the second connecting rod 122 so that the user can take off the display 14 for operation, thereby improving the flexibility of the operation of the display 14. Alternatively, the display 14 is rotatably disposed on the second connecting rod 122 so that the user can adjust the angle of the display 14 according to factors such as the surrounding environment and the height of the user to view the content displayed on the display 14 more clearly or operate the display 14, and the display 14 is convenient to store when the second connecting rod 122 is folded. Alternatively, the display 14 is detachably and rotatably disposed on the second connecting rod 122 so that the user can take off the display 14 for operation, improving the flexibility of the operation of the display 14, and the user can adjust the angle of the display 14 according to factors such as the surrounding environment and the height of the user to view the content displayed on the display 14 more clearly or operate the display 14.

If the display 14 is detachably disposed on the second connecting rod 122, at least two installation positions for mounting the display 14 may be disposed on the second connecting rod 122 or at least two mounting portions 6 for mounting the display 14 may be disposed on the second connecting rod 122, and the display 14 is rotatable or non-rotatable. The structure of the mounting portion 6 disposed on the second connecting rod 122 may be the same as or different from the structure of the preceding mounting portion of the first connecting rod 121, which is not specifically limited here.

If the display 14 is detachable, at least one mounting position may be disposed on each of the first connecting rod 121 and the second connecting rod 122, the user may mount the display 14 on the first connecting rod 121 or the second connecting rod 122 according to usage habits, and the display 14 is rotatable or non-rotatable.

As shown in FIGS. 47 and 48, in some examples, the connecting rod assembly 12 includes the first connecting rod 121 and the second connecting rod 122, the mounting portion 6 is disposed between the first connecting rod 121 and the second connecting rod 122, the mounting portion 6 connects the first connecting rod 121 to the second connecting rod 122, and the display 14 is detachably and/or rotatably disposed on the mounting portion 6. The mounting portion 6 connecting the first connecting rod 121 to the second connecting rod 122 plays a role of lateral support, provides the installation carrier for the installation of the display 14, and provides a safe interior space for the display 14.

The display 14 is detachably disposed on the mounting portion 6 so that the user can take off the display 14 for operation, thereby improving the flexibility of the operation of the display 14. Alternatively, the display 14 is rotatably disposed on the mounting portion 6 so that the user can adjust the angle of the display 14 according to factors such as the surrounding environment and the height of the user to view the content displayed on the display 14 more clearly or operate the display 14, and the display 14 is convenient to store when the connecting rod assembly 12 needs to be folded. Alternatively, the display 14 is detachably and rotatably disposed on the mounting portion 6 so that the user can take off the display 14 for operation, improving the flexibility of the operation of the display 14, and the user can adjust the angle of the display 14 according to factors such as the surrounding environment and the height of the user to view the content displayed on the display 14 more clearly or operate the display 14.

If the display 14 is detachably disposed on the mounting portion 6, then at least two installation positions for mounting the display 14 may be disposed on the mounting portion 6, and the display 14 is rotatable or non-rotatable.

If the display 14 is detachable, in addition to setting the installation position on the mounting portion 6 connecting the first connecting rod 121 to the second connecting rod 122, at least one installation position may be set on the first connecting rod 121 and/or the second connecting rod 122 separately, the user may mount the display 14 on the mounting portion 6, the first connecting rod 121, or the second connecting rod 122 according to usage habits, and the display 14 is rotatable or non-rotatable.

As shown in FIG. 48, if the mounting portion 6 is disposed between the first connecting rod 121 and the second connecting rod 122, the distance L2 between the centerline of the holding handle 13 and the lower boundary 1402 of the electronic display screen 1401 of the display 14 may be 50 mm, 90 mm, 70 mm, or 110 mm. Under the premise that the user holds the holding handle 13 without blocking the display 14, the display 14 is not too far away from the user, thereby ensuring that the user can clearly view the display information on the display 14.

In some examples, as shown in FIGS. 46 and 49, the display 14 is disposed on the holding handle 13, or the mounting portion 6 for mounting the display 14 is disposed on the holding handle 13.

The display 14 is detachably and/or rotatably disposed on the holding handle 13 or the mounting portion 6 so that the display 14 is convenient for the user to operate and view.

If the display 14 is detachably disposed on the holding handle 13 or the mounting portion 6, at least two installation positions for setting the display 14 are disposed on the holding handle 13 or the mounting portion 6, and the display 14 is rotatable or non-rotatable.

When the display 14 is detachable, in addition to setting the installation position on the holding handle 13 or the mounting portion 6 of the holding handle 13, at least one installation position may be set on the preceding first connecting rod 121 and/or the second connecting rod 122 and/or the mounting portion 6 connecting the first connecting rod 121 to the second connecting rod 122 separately, the user may mount the display 14 on the holding handle 13, the mounting portion 6, the first connecting rod 121, or the second connecting rod 122 according to usage habits, and the display 14 is rotatable or non-rotatable.

Referring to FIGS. 50 and 51, in some examples, the connecting rod assembly 12 is bent, that is, the connecting rod assembly 12 includes a first section and a second section connected in sequence, the first section is connected to the body 11, the first section extends along a first centerline 103, the second section extends along a second centerline 104, and the length of the first section is greater than the length of the second section. The walk-behind mower is placed on the horizontal plane, the connecting rod assembly 12 is set at the maximum angle for the user to push (that is, a shown in the figure is the minimum angle), and the display 14 is disposed between the holding handle 13 and the pivot axis 102. At this time, the distance L4 between the projection of the lower boundary 1402 of the electronic display screen 1401 of the display 14 on the horizontal plane and the projection of the first end 1201 of the connecting rod assembly 12 on the horizontal plane is greater than 70 mm. α is between 30 degrees and 60 degrees.

Based on any of the technical solutions described above, as shown in FIGS. 52 and 53, the connecting rod assembly 12 is foldable. When the walk-behind mower is in a folded state, the walk-behind mower is placed on the same horizontal plane, the projection of the walk-behind mower on the horizontal plane forms a first region, and the display 14 is at least partially or completely located in the first region 105 so that the display 14 is convenient for the user to store.

The preceding connecting rod assembly 12 may be a telescopic structure, which is not specifically limited here.

Referring to FIGS. 54 and 55, the display 14 includes the transparent cover 141, the circuit board 144, the fixed cover 145, a housing 146, and a light emitter 147. The housing 146 and the fixed cover 145 are connected to surround an accommodation space. An observation window is opened on the housing 146. The transparent cover 141 is mounted on the observation window. The circuit board 144 and the light emitter 147 are disposed in the accommodation space. The light emitter 147 is electrically connected to the circuit board 144. The light emitter 147 is an LED or organic light-emitting diode (OLED) component. Compared with the structure of the display in the existing art, the display lacks a light guide member, thereby simplifying the structure and improving the display effect.

Referring to FIG. 56, the content displayed on the display 14 may include a self-traveling mode display region 71, a load display region 72, a power display region 73, a rotational speed mode display region 74, a maintenance indication region 75, an over-temperature indication region 76, a connecting rod assembly state indication region 77, a light indication region 78, and a Bluetooth indication region 79, the displayed content is comprehensive, and it is convenient for the user to know the working state of the walk-behind mower in time.

In an example, as shown in FIG. 42, the first connecting rod 121 and the second connecting rod 122 are connected through a connector 150, and the mounting portion is disposed on the connector 150.

In some examples, as shown in FIGS. 57 and 58, the walk-behind mower further includes the display 14. The display 14 includes the electronic display screen 1401. The display 14 is disposed on the body. When the mower 100 is placed on the horizontal plane, the electronic display screen 1401 forms an included angle β with the horizontal plane. The included angle β is greater than or equal to 0 degrees and less than or equal to 90 degrees.

The display 14 is disposed on a top surface 61 or a side surface of the body 11, the electronic display screen 1401 of the display 14 can be set upward or toward the user, and the included angle between the display 14 and the top surface 61 or the side surface of the body 11 is adjustable.

When the electronic display screen 1401 is set toward the user, the position of the user is as follows: the user holds the grip 13, and the movement direction of the user is basically the same as the movement direction of the walk-behind mower.

The display 14 is disposed on the top surface 61 or the side surface of the body 11, and the electronic display screen 1401 of the display 14 faces upward or toward the user so that it is convenient for the user to view the content displayed on the display 14; at the same time, the position of the display 14 is relatively far away from the holding handle 13, not affecting the user holding the holding handle 13; the included angle between the display 14 and the top surface 61 or the side surface of the body 11 is adjustable, so as to adapt to the external factors such as the usage habits or height of the user, which is convenient for the user to view the information displayed on the display 14.

In an example, the display 14 is disposed on a power supply enclosure of the body 11 and may be disposed on the side surface or top surface of the power supply enclosure, which is not specifically limited here. The body 11 further includes a housing supporting the walking assembly 111, and the display 14 may be disposed on the housing supporting the walking assembly 111 at a position convenient for observation.

In an example, as shown in FIGS. 59 and 60, the display 14 is disposed on the top surface 61 of the body 11, and the electronic display screen 1401 of the display 14 can be set upward so that the user views or operates the display 14 from top to bottom; or the electronic display screen 1401 of the display 14 is set at an included angle with the top surface 61, and the electronic display screen 1401 of the display 14 faces the user. To sum up, the included angle between the electronic display screen 1401 of the display 14 and the top surface 61 may be 0°-90°.

The included angle between the display 14 and the top surface 61 is adjustable. To implement this function, a mounting portion is disposed on the top surface 61 of the body 11, and the display 14 is rotatably disposed on the top surface 61 of the body 11 through the mounting portion.

In some examples, the mounting portion includes a hinge shaft connecting the body 11 to the display 14, and a self-locking part is disposed on the hinge shaft. When the display 14 rotates, the self-locking part can position the display 14 at any position. The self-locking part may also be configured to position the display 14 at a specific angle. Specifically, the structures of the hinge shaft and the self-locking part are the existing art and are not specifically limited here.

When the walk-behind mower is used, the user may adjust the angle of the display 14 so that the display 14 forms a certain included angle with the top surface of the body 11. When the walk-behind mower is used up, the user may lay the display 14 flat, that is, the back of the display 14 fits the top surface of the body 11. The mounting portion provided above can enable the back of the display 14 to fit the top surface of the body 11.

In some examples, the display 14 is detachable, at least two installation positions for mounting the display 14 are disposed on the top surface of the body 11, the user adjusts the position of the display 14 according to usage habits, and the included angle between the display 14 and the top surface 61 of the body 11 is adjustable.

In some examples, as shown in FIG. 61, a first accommodation groove is disposed on the top surface 61 of the body 11, the display 14 is disposed in the first accommodation groove, and the electronic display screen 1401 of the display 14 can be flush with the top surface 61 of the body 11 so that the display 14 can be completely accommodated, thereby reducing the risk of the display 14 being damaged. The display 14 may be detachably connected to the first accommodation groove so that the display 14 can be mounted at different installation positions.

In some examples, a second accommodation groove is disposed on the top surface 61 of the body 11, the display 14 is rotatably disposed in the second accommodation groove, the electronic display screen 1401 of the display 14 can be set upward, an observation window is disposed at the notch of the second accommodation groove to protect the display 14 from being damaged, the user may open the observation window and adjust the angle of the display 14 according to usage habits, and when the walk-behind mower is not in use, the user may accommodate the display 14 in the second accommodation groove and close the observation window.

The side surfaces include a rear side surface 621 facing the user and a left side surface 622 and a right side surface 623 disposed on two sides of the top surface 61.

With continued reference to FIG. 61, when the display 14 is disposed on the rear side surface 621, the included angle between the electronic display screen of the display 14 and the rear side surface 621 may be 0° to 45° so that the user can view the electronic display screen 1401 of the display 14.

The included angle between the display 14 and the rear side surface 621 is adjustable. To implement this function, a mounting portion is disposed on the rear side surface 621 of the body 11, and the display 14 is rotatably disposed on the rear side surface 621 of the body 11 through the mounting portion.

In some examples, the mounting portion includes a hinge shaft connecting the body 11 to the display 14, and a self-locking part is disposed on the hinge shaft. When the display 14 rotates, the self-locking part can position the display 14 at any position. Specifically, the structures of the hinge shaft and the self-locking part are the existing art and are not specifically limited here.

When the walk-behind mower is used, the user may adjust the angle of the display 14 so that the display 14 forms a certain included angle with the rear side surface 621 of the body 11. When the walk-behind mower is used up, the user may lay the display 14 flat, that is, the back of the display 14 fits the rear side surface 621 of the body 11. The mounting portion provided above can enable the back of the display 14 to fit the rear side surface 621 of the body 11.

In some examples, the display 14 is detachable, at least two installation positions for mounting the display 14 are disposed on the rear side surface 621 of the body 11, the user adjusts the position of the display 14 according to usage habits, and the included angle between the display 14 and the rear side surface 621 of the body 11 is adjustable. Alternatively, at least one installation position is set on each of the rear side surface 621 and the top surface 61 of the body 11.

In some examples, as shown in FIG. 61, a first accommodation groove is disposed on the rear side surface 621 of the body 11, the display 14 is rotatably disposed in the first accommodation groove, and the electronic display screen of the display 14 can be flush with the rear side surface 621 of the body 11 so that the display 14 can be completely accommodated, thereby reducing the risk of the display 14 being damaged. The display 14 may be detachably connected to the first accommodation groove so that the display 14 can be mounted at different installation positions.

In some examples, a third accommodation groove is disposed on the rear side surface 621 of the body 11, the display 14 is rotatably disposed in the third accommodation groove, the electronic display screen 1401 of the display 14 is set toward the user, an observation window is disposed at the notch of the third accommodation groove to protect the display 14 from being damaged, the user may open the observation window and adjust the angle of the display 14 according to usage habits, and when the walk-behind mower is not in use, the user may accommodate the display 14 in the third accommodation groove and close the observation window.

Referring to FIG. 58, when the display 14 is disposed on the left side surface 622 or the right side surface 623, the included angle between the electronic display screen 1401 of the display 14 and the left side surface 622 or the right side surface 623 may be 45° to 135°, thereby ensuring that the electronic display screen 1401 of the display 14 faces the user at a proper angle, which is convenient for the user to view the electronic display screen 1401. Alternatively, the included angle between the electronic display screen 1401 of the display 14 and the top surface 61 is 0° to 90° so that the electronic display screen 1401 faces upward or toward the user, which is convenient for the user to view the electronic display screen 1401. Alternatively, the angle of the display 14 is adjustable in two directions, that is, not only can the included angle between the electronic display screen 1401 and the left side surface 622 or the right side surface 623 be adjusted, but also the included angle between the electronic display screen 1401 and the top surface 61 can be adjusted, thereby ensuring that the user can see the electronic display screen 1401 clearly.

The included angle between the display 14 and the left side surface 622 or the right side surface 623 is adjustable. To implement this function, a mounting portion is disposed on the left side surface 622 or the right side surface 623 of the body 11, and the display 14 is rotatably disposed on the left side surface 622 or the right side surface 623 of the body 11 through the mounting portion.

In some examples, if the included angle between the electronic display screen 1401 of the display 14 and the left side surface 622 or the right side surface 623 is adjustable or the included angle between the electronic display screen 1401 of the display 14 and the top surface 61 is adjustable, then the mounting portion includes a hinge and a connecting seat, the hinge is connected to the connecting seat, the hinge seat is rotatable, the display 14 is mounted on the hinge seat, and a self-locking part is disposed on the hinge so that the connecting seat can be positioned at any position.

If the adjustment angle of the display 14 is adjustable in two directions, the mounting portion includes the hinge connecting the body 11 to the display 14, the hinge is rotatably connected to the connecting seat, the display 14 is disposed on the connecting seat, the self-locking part is disposed on the hinge, the self-locking part is disposed between the hinge and the connecting seat, and when the display 14 rotates, the self-locking part can enable the display 14 to be positioned at any position. Specifically, the connection structures between the hinge shaft, the connecting seat, and the self-locking part are the existing art and are not specifically limited here.

When the walk-behind mower is used, the user may adjust the angle of the display 14 so that the display 14 forms a certain included angle with the left side surface 622, the right side surface 623, or the top surface 61 of the body 11. When the walk-behind mower is used up, the user may lay the display 14 flat so that the back of the display 14 fits the left side surface 622 or the right side surface 623 of the body 11. The mounting portion provided above can enable the back of the display 14 to fit the left side surface 622 or the right side surface 623 of the body 11.

In some examples, the display 14 is detachable, at least one installation position for the user to mount the display 14 is set on each of the left side surface 622 and the right side surface 623 of the body 11, or at least two installation positions are set on the left side surface 622 or the right side surface 623, the user adjusts the position of the display 14 according to usage habits, and the included angle between the display 14 and the left side surface 622, the right side surface 623, or the top surface 61 of the body 11 is adjustable. Alternatively, at least one installation position is set on any two or more of the rear side surface 621, the top side 61, the left side surface 622, and the right side surface 623 of the body 11.

In some examples, a first accommodation groove is disposed on the left side surface 622 or the right side surface 623 of the body 11, the display 14 is rotatably disposed in the first accommodation groove, and the electronic display screen 1401 of the display 14 can be flush with the left side surface 622 or the right side surface 623 of the body 11 so that the display 14 can be completely accommodated, thereby reducing the risk of the display 14 being damaged. The display 14 may be detachably connected to the first accommodation groove so that the display 14 can be mounted at different installation positions. The connecting rod assembly 12 may be a telescopic structure, which is not specifically limited here.

FIG. 66 is a structural diagram of a wheeled working machine provided in the embodiments of this application, specifically a walk-behind lawn mower, hereinafter referred to as the “lawn mower”. To clearly illustrate the technical solution of this application, the directions shown in FIG. 66 are defined as: front, rear, left, right, up, and down, wherein, the front-rear direction can also be understood as the length direction of the walk-behind lawn mower, the left-right direction can be understood as the width direction of the walk-behind lawn mower, and the up-down direction can be understood as the height direction of the walk-behind lawn mower.

In the embodiments of this application, as shown in FIGS. 66 and 67, the lawn mower 100 mainly includes a body 76, a handle device 78, and a connecting rod assembly 77. The body 11 includes a walking assembly 111 and a walking drive assembly (not shown) that drives the walking assembly 111. The walking assembly 111 is a wheel assembly. The body 11 also includes a working assembly 113 and a cutting drive assembly (not shown) that drives the working assembly 113. Specifically, the working assembly 113 is a cutting assembly, such as a cutting blade. The handle device 13 includes a gripping portion 131 for the user to hold. The connecting rod assembly 12 connects the body 11 to the handle device 13 and is pivotally connected to the body 11 about a pivot axis 102. The connecting rod assembly 12 can be folded above the body 11 for easy storage. It is understandable that other wheeled working machines, such as snow blowers, may also include components like the handle device 13, body 11, walking assembly 111, and gripping portion 131.

As shown in FIGS. 66 and 67, the lawn mower 100 includes a display 84. The display 84 includes a display screen 841 embedded in a frame. After the display 84 is activated, relevant information of the lawn mower 100 is displayed on the display screen 841 of the display 84, such as the machine's operating mode, walking speed, battery level, fault information, etc. The display 84 is located at an end of the connecting rod assembly 12 and near the handle device 13. It should be noted that the display 84 can be not only fixedly mounted on the connecting rod assembly 12, but also slidably or rotatably connected to the connecting rod assembly 12. For example, the angle of the display 84 can be adjusted according to user needs, or the display 84 can be stowed by sliding or rotating when not needed. In one embodiment, the display 84 can also be located on the handle device 13 or the body 11. No restrictions are imposed on the specific position and connection method of the display 84.

The display 84 is foldable. FIG. 66 shows the display in an unfolded state, while FIG. 67 shows it in a folded state. Unfolding the display 84 increases the display area to form a large screen display, while folding the display 84 reduces the display area to form a small screen display. The display area refers to the area of the effective region on the screen capable of displaying images, text, or other content, i.e., the visible area of the screen, also simply referred to as the area. For a rectangular display screen, the display area is the length of the display region multiplied by its width.

As shown in FIGS. 68A-68B and FIGS. 69A-69B, in one embodiment, the display 84 includes a flexible screen 842 embedded in the frame, that is, the display screen 841 itself is a flexible screen 842, which has the characteristics of being bendable and foldable. The flexible screen 842 can be folded along fold lines 843 to form multiple (two or more) screens. The fold lines 843 may extend in the vertical direction, allowing the display 84 to be folded left and right.

For example, the flexible screen 842 shown in FIG. 68A is in its unfolded state. After folding left and right along the fold line 843, it can form screen A and screen B as shown in FIG. 68B. Another example, the flexible screen 842 shown in FIG. 69A includes two fold lines 843. After folding along the fold lines 843, it can form screen A, screen B, and screen C as shown in FIG. 69B. FIGS. 68A and 69A both show the flexible screen 842 in its unfolded state, while FIGS. 3B and 4B show the flexible screen 842 in a folding state. The right figure in FIG. 68B shows the flexible screen in a fully folded state. When the flexible screen 842 is fully folded, the angle between adjacent screens is 0°. When the flexible screen 842 is unfolded, the angle between adjacent screens is 180°. The flexible screen 842 can also be folding in a semi-folded state, meaning not fully folded, with the angle between adjacent screens ranging from (0°,) 180°. For example, in the unfolded state shown in FIGS. 68A and 69A, the angle between screen A and screen B, and between screen B and screen C, is 180°. If fully folded, the angle between screen A and screen B, and between screen B and screen C, becomes 0°.

As shown in FIG. 70, in another embodiment, the display 84 includes multiple pivotally connected screens, forming a multi-screen foldable display. This display 84 includes multiple (two or more) screens, which can be sequentially connected via folding axes 846. Each screen can rotate about its connected folding axis 846, realizing a multi-screen foldable display. The folding axes 846 may extend in the vertical direction, allowing the display 84 to be folded left and right.

As shown in FIG. 70, the display 84 includes two screens, referred to as the first screen 844 and the second screen 845. The first screen 844 and the second screen 845 are connected by a folding axis 846 extending in the vertical direction. The first screen 844 and the second screen 845 can rotate about the folding axis 846 to fold left and right. The first screen 844 and the second screen 845 can be ordinary display screens or flexible screens, which is not restricted here. The left figure in FIG. 70 shows the state where the two screens are unfolded, while the right figure shows the state where the two screens are folding. When the first screen 844 and the second screen 845 are fully folded, the angle between adjacent screens is 0°. When the two screens are unfolded, the angle between adjacent screens is 180°. When the two screens are in a semi-folded state, the angle between adjacent screens ranges from (0°,) 180°. The multi-screen foldable display can also include three or more screens; its specific form and folding method can be referred to FIG. 70 and related descriptions, which will not be repeated here.

As shown in FIG. 71, in one embodiment, the fold lines 843 of the flexible screen 842 can extend in the horizontal direction, allowing the display 84 to be folded up and down. The flexible screen 842 shown in the left figure of FIG. 71 is in its unfolded state. After folding up and down along the fold line 843, it can form screen A and screen B as shown in the right figure of FIG. 71.

In one embodiment, the fold lines 843 can also extend diagonally, allowing the display 84 to be folded diagonally. In another embodiment, the fold lines 843 can extend in other angular directions; the specific angle range is not limited here. In one embodiment, the folding method can also be rolling, rolling horizontally from one end of the flexible screen 842 to the other end, or vertically from one end of the flexible screen 842 to the other end.

In some embodiments, the multi-screen foldable display can also fold up and down, with the folding axis 846 extending horizontally. The first screen 844 and the second screen 845 rotate about the folding axis 846 to fold up and down.

The display 84 can show linked content across multiple screens. Linked display means that multiple screens form a collaborative association to jointly display a complete content, with a single screen displaying only part of the content, combining to form a complete view. For example, unfolded screen A and screen B jointly display relevant machine information, including walking speed, cutting speed, and battery level information. Alternatively, the unfolded first screen 844 and second screen 845 jointly display an electronic map of the work area. In one embodiment, the multiple screens of display 84 can also display partitioned content. Partitioned display means each screen independently displays different information, and each screen (or partition) functions as an independent screen. For example, screen A displays the machine's walking direction and speed, screen B displays battery level and fault information, and screen C displays an electronic map of the work area. Or, the first screen 844 displays the machine's power information (e.g., speed), and the second screen 845 displays a navigation map of the work area.

In this embodiment, the display area of each screen among the multiple screens of the display 84 is substantially the same. For example, in FIG. 68A, the display 84 includes two screens, screen A and screen B. The unfolded display area (area enclosed by bold lines in the figure) is denoted as S. The display areas of screen A and screen B are substantially the same. The display area of screen A is denoted as S_{A}, the display area of screen B is denoted as S_{B}; and the unfolded area S is substantially equal to the sum of S_{A} and S_{B}, and the area of the display 84 when fully folded (S_{A} or S_{B}) is one-half of the unfolded area(S). In another example, the display 84 includes screen A, screen B, and screen C. The area of screen C is denoted as S_{C}; the unfolded area S is substantially equal to S_{A}+S_{B}+S_{C}, and the area of the display 84 when fully folded (S_{A} or S_{B} or S_{C}) is one-third of the unfolded area(S). In yet another example, the display 84 includes screen A, screen B, screen C, and screen D, with the display area of the screen D being denoted as S_{D}; the unfolded area S is substantially equal to S_{A}+S_{B}+S_{C}+S_{D}, and the area when the display 84 is fully folded is one-quarter of the unfolded area(S).

In this embodiment, the display 84 is foldable. Unfolding the display 84 can increase the display area. The ratio of the area of the folded display 84 to the area of the unfolded display 84 is greater than or equal to one-quarter and less than or equal to one-half. During use, unfolding the display 84 increases the display area to form a large screen, allowing clearer presentation of information content and the display of more machine-related information. When limited or minimal information needs to be displayed, folding the display 84 hides part of the screen to form a small screen, using only part of the screen to display information. This saves space, avoids obstructing the user's view, and when folding and storing the lawn mower 200, the display 84 can be folded to occupy only the space of a single screen, saving space and facilitating storage.

Understandably, in another embodiment, the areas of the multiple screens may not be equal. For example, screen A and screen B are large and small screens, where the area S_{A} of screen A is 1.1-2 times the area S_{B} of screen B. After folding, screen A can be retained to display information, or screen B can be retained.

The display screen 841 of the display 84 may be a flexible OLED screen 840, i.e., a flexible display screen based on flexible organic light-emitting diode technology. It can be understood that the flexible screen 842 is implemented as a flexible OLED screen 840. Flexible OLED screens have vivid colors and high contrast, capable of presenting clear images and realistic colors. The bezel width (the structure between the display boundary of the screen and the physical boundary of frame of the screen) of the flexible OLED screen 840 is less than or equal to 3 mm, making it an ultra-narrow bezel flexible screen. This enlarges the viewable area, increases the screen-to-body ratio for the same size, and visually presents an almost “full-screen” display effect, showing more content.

The display screen 841 of the display 84 can also use an electronic ink screen, which has a paper-like display effect, offering high readability, being non-glaring, and consuming low power. This is very suitable for the long viewing usage scenarios of lawn mowers. The bezel width of the electronic ink screen is less than or equal to 5 mm; the narrow bezel can enlarge the display area to show more information content.

The screen size of the display screen 841 of the display 84 is implemented as 3.5-7 inches, with a resolution greater than or equal to 720P (pixels). For example, resolutions include but are not limited to 720P, 1080P, 1280P. The high resolution of the display 84 allows it to display information clearly. The viewing angle of the display screen 841 is greater than or equal to 170°. Specifically, both the horizontal and vertical viewing angles are greater than or equal to 170°, ensuring the display screen 841 is clearly visible when operating the lawn mower 100 from either side.

As shown in FIGS. 66, 67, and 72, the display 84 is installed at the end of the connecting rod assembly 12. When observing the display 84 from a direction perpendicular to its display interface, only one edge of the display 84 is connected to the connecting rod assembly 12. As shown in FIG. 72, the bottom edge of the display 84 is connected to the connecting rod assembly 12. Understandably, the edge connected to the connecting rod assembly 12 could also be a side edge or the top edge. In one embodiment, only one edge of the display 84 is connected to the handle device 13 or the body 11.

In one embodiment, the display 84 can also be an external device, such as a smartphone or tablet, placed on the lawn mower 100 to serve as the display 84 of the lawn mower 100, displaying relevant information of the lawn mower 100.

As shown in FIG. 72, it shows a partial enlarged view of the connecting rod assembly and handle device from FIG. 66. The connecting rod assembly 12 includes a pair of connecting rods, referred to as the first connecting rod 121 and the second connecting rod 122. A transverse connecting structure 124 is provided between the first connecting rod 121 and the second connecting rod 122. The transverse connecting structure 124 is connected to the ends of the first connecting rod 121 and the second connecting rod 122, near the handle device 13. The display 84 is detachably and/or rotatably arranged on the transverse connecting structure 124. The transverse connecting structure 124 connects the first connecting rod 121 and the second connecting rod 122, providing transverse support. The transverse connecting structure 124 also provides an installation carrier for the display 84 and offers a secure internal space for the display 84.

The display 84 may be detachably arranged on the transverse connecting structure 124. Users can remove the display 84 for operation, improving the flexibility of operating the display 84. Alternatively, the display 84 is rotatably arranged on the transverse connecting structure 124. Specifically, it can rotate in the front-rear direction. Users can adjust the angle of the display 84 based on the surrounding environment and their own height for clearer viewing of the content displayed on the display 84 or for operating the display 84. This also facilitates stowing the display 84 when folding the connecting rod assembly 12 is necessary. Or, the display 84 can be both detachably and rotatably arranged on the transverse connecting structure 124. This allows the user to remove the display 84 for operation, enhancing flexibility, and also allows the user to adjust the angle of the display 84 according to factors such as the surrounding environment and his or her own height, so as to more clearly view the content displayed on the display 84 or operate the display 84.

As shown in FIGS. 73 and 74, in one embodiment, the display 84 can rotate in the left-right direction. Specifically, the bottom edge of the display 84 is connected to the transverse connecting structure 124 via a rotation shaft 847. The axis of the rotation shaft 847 extends in a front-rear direction. The display 84 can rotate to the left or right around the rotation shaft 847. During the operation of the lawn mower 100, the body of the lawn mower 100 may tilt to the left or right. When the body tilts, the display 84 is rotated in the opposite direction to tilt the display 84 to the right or left around the rotation axis 847. The tilt angle of the display 84 is adjusted so that the display screen 841 remains basically horizontally visible, so that the user can still view the display 84 horizontally. FIG. 73 shows an installation state of the display when the body is not tilted. FIG. 74 shows the state where the display is rotated to the left when the body tilts to the right.

In one embodiment, the display 84 can rotate along its bottom left edge and/or bottom right edge. For example, the bottom left and right edges of the display 84 are respectively connected to the transverse connecting structure 124 via rotation shafts 847. In the left-right direction, this allows the display 84 to rotate upward to the left around the left rotation shaft 847, and to rotate upward to the right around the right rotation shaft 847.

Specifically, the lawn mower 100 also includes an attitude sensor for detecting the tilt angle of the lawn mower's body. The body tilt angle refers to the angle between the body's vertical central plane and a vertical plane. The vertical central plane extends along the front-rear direction of the lawn mower 100, and the lawn mower body is substantially symmetrically distributed left and right about this vertical central plane. The body tilt angle can also be understood as the tilt angle of the first plane 125 formed by the first connecting rod 121 and the second connecting rod 122. Specifically, the attitude sensor is a gyroscope. If the gyroscope detects a body tilt angle of 10° to the left, the display is rotated 10° to the right, ensuring the user still views the display 84 horizontally.

In one embodiment, the lawn mower 100 can detect the body tilt angle to automatically adjust the reverse rotation of the display 84 to keep the display screen 841 horizontally viewable. Specifically, based on the body tilt angle detected by the attitude sensor, as well as the installation posture of the display 84, the angle by which the display 84 should be rotated in reverse is calculated. The display 84 is then driven to rotate in reverse by this angle, adjusting it to remain horizontal and keeping the display screen 841 horizontally viewable.

Illustratively, as shown in FIG. 73, when the body is not tilted, the horizontal centerline 848 of the display 84 is substantially parallel to the horizontal plane, and the vertical centerline 849 of the display 84 is substantially parallel to the vertical plane. The horizontal centerline 848 and vertical centerline 849 pass through the geometric center of the display 84. The tilt angle of the body is also the tilt angle between the vertical centerline 849 of the display 84 and the vertical plane, and also the tilt angle between the horizontal centerline 848 of the display 84 and the horizontal plane. As shown in FIG. 74, if the gyroscope detects a body tilt angle α to the right (also the tilt angle of the first plane 125 is a), the unrotated position of the display 84 is shown by the dotted line. To facilitate viewing by a user standing upright, the display 84 is rotated to tilt left by angle α. The rotated position of the display 84 is shown by the solid line, ensuring the user still views the display 84 horizontally.

In one embodiment, body tilt may include tilting in multiple directions, both left-right and front-rear. When the body of the lawn mower 100 tilts in multiple directions, the angle of the display 84 can be simultaneously compensated in both the front-rear and left-right directions to keep the display screen 841 within the user's viewable range.

The display screen 841 may be a dual-mode touch screen, specifically integrating capacitive touch and infrared touch modes. It supports finger touch and gloved operation, facilitating user interaction with the display screen 841. The screen of the display screen 841 achieves IP67 level water and dust resistance. The surface of the screen is coated with an oleophobic layer to prevent fingerprints.

FIGS. 75 to 77 show more implementable configurations of the display 14 for the wheeled working machine. Features of the wheeled working machine described in the embodiments of FIGS. 66 to 74 that are compatible with this implementation can be applied to this embodiment. FIG. 75 shows a walk-behind lawn mower. As shown in FIG. 75, the lawn mower 100 mainly includes a body 11, a handle device 13, a connecting rod assembly 12, and a display 14. The body 11 includes a walking assembly 111 and a drive assembly (not shown) that drives the walking assembly 111. The body 11 also includes a working assembly 113. The working assembly is a cutting blade for cutting grass. The handle device 13 includes a gripping portion 131 for the user to hold. The connecting rod assembly 12 connects the body 11 to the handle device 13. The display 14 is installed at the end of the connecting rod assembly 12, near the handle device 13. The display 14 displays relevant information of the lawn mower 100.

As shown in FIG. 76, the lawn mower 100 also includes a control panel 83. The control panel 83 includes several buttons for controlling the operating state of the lawn mower 100. The buttons can be physical keys or knobs. Specifically, the buttons can include a self-traveling mode switch 136, a light switch 135, a blade mode switch 134, a walking speed adjustment switch 137, a cutting speed adjustment switch 138, etc. Different buttons correspond to different commands and can execute different functions. Understandably, each button is configured to perform its distinct function.

Among them, the self-traveling mode switch 136 is configured to adjust the walking mode of the lawn mower 100, which includes a self-propelled mode and a push mode. In the self-propelled mode, the lawn mower 100 can adjust its walking speed based on the magnitude of thrust applied by the user. In the push mode, the lawn mower 100 cannot move autonomously and relies solely on the force applied by the user pushing it. When the display 14 is lit, the current walking mode information of the lawn mower 100 is displayed on the display 14. If the user then triggers the self-traveling mode switch 136 to adjust the walking mode of the lawn mower 100, for example, changing from the push mode to the self-propelled mode, the display 14 accordingly shows that the lawn mower 100 changes from the push mode to the self-propelled mode. The blade mode switch 134, i.e., the lock-off button, is configured to control the start and stop of the lawn mower's cutting blade. The light switch 135 is configured to control functions such as turning the lawn mower's lights on, off, and adjusting brightness. When the lawn mower's lights are on, the display 14 correspondingly displays this status.

The walking speed adjustment switch 137 is configured to control the self-propelled speed of the lawn mower 100; specifically, it may include a low-speed adjustment switch and a high-speed adjustment switch, indicated by different icons. When the display 14 is lit, pressing the walking speed adjustment switch 137 adjusts the lawn mower to walk at a low or a high speed. The cutting speed adjustment switch 138 controls the rotational speed of the lawn mower 100's cutting blades; specifically, it may include a switch for increasing blade speed and a switch for decreasing blade speed, represented by “+” and “−” icons, respectively. When the display 14 is lit, pressing the cutting speed adjustment switch 138 increases or decreases the blade rotation speed of the lawn mower 100.

In this embodiment, the blade mode switch 134, the self-traveling mode switch 136, and/or the light switch 135 are also configured to light up the display 14. When the display 14 lights up, relevant information of the lawn mower 100 is displayed on the display 14. It can be understood that a dedicated activation switch for the display might not be separately provided; the display 14 can be lit up by any one of the blade mode switch 134, self-traveling mode switch 136, and light switch 135. When the display 14 is not lit, a first activation of any one of these switches (the blade mode switch 134, the self-traveling mode switch 136, the light switch 135) lights up the display 14, and a subsequent activation of the same switch performs its original function. For example, when the display 14 is not lit, a first activation of the blade mode switch 134 lights up the display 14; a second activation of the blade mode switch 134 adjusts the cutting blade rotation speed. When the display 14 is not lit, a first activation of the light switch 135 lights up the display 14; a second activation of the light switch 135 turns the lights on. In one embodiment, lighting up of the display 14 can also be achieved by activation of a combination of any multiple switches among the blade mode switch 134, the self-traveling mode switch 136, and the light switch 135. After the display 14 is lit, each switch restores its original function. Integrating the display lighting up function into the blade mode switch 134, the self-traveling mode switch 136, and/or the light switch 135 eliminates the need for a separate display switch, simplifying the user operation flow, saving space on the control panel 83, and reducing costs.

In some embodiments, the function of lighting up the display 14 can also be integrated into other buttons, such as the walking speed adjustment switch 137, the cutting speed adjustment switch 138, the folding switch, the body switch, etc. Understandably, other solutions integrating this function into another button falls within the scope of this application.

Referring to FIG. 76, in one embodiment, the control panel 83 and the display 14 are integrated together. Several buttons on the control panel 83 are distributed around the periphery of the display screen 1403 of the display 14. The display 14 is positioned at the center of the control panel 83. In one embodiment, the display screen 1403 of the display 14 is substantially rectangular and substantially symmetrical about a vertical centerline 1404. The control panel 83 is also substantially symmetrical about the vertical centerline 1404. Specifically, the buttons are arranged in an arc along the edge of the display screen 1403, with an arc radius of 10-15 cm, so that the user's fingers can naturally trigger the buttons when holding the gripping portion 131. For example, the walking speed adjustment switch 137 is located in the left hand side of the display screen 1403. Below the display screen 1403, from left to right, are the light switch 135, the self-traveling mode switch 136, and the blade mode switch 134. The cutting speed adjustment switch 138 is located in the right hand side of the display screen 1403.

Referring to FIG. 77, the content displayed on the display 14 can include a self-propelled mode indicator zone 71, a load indicator zone 72, a battery level indicator zone 73, a speed mode indicator zone 74, a maintenance indicator zone 75, an overtemperature indicator zone 76, a connecting rod assembly status indicator zone 77, a lighting indicator zone 78, and a Bluetooth indicator zone 79. The displayed content is comprehensive, facilitating timely understanding of the working status of the walk-behind lawn mower 100 by the user.

As shown in FIG. 77, the indicator zones on the display screen 1403 correspond to the functions of the buttons. The lighting indicator zone 78 is near the light switch 135. The self-propelled mode indicator zone 71, which displays the self-propelled mode, the push mode, or the self-propelled speed, is near the self-traveling mode switch 136 or the walking speed adjustment switch 137. The speed mode indicator zone 74 is near the cutting speed adjustment switch 138. Linking the display screen's indicator zones to button functions achieves consistency between visual feedback and operation, enhancing the user experience.

In one embodiment, the indicator zones of the display screen 1403 correspond to the functional zones on the control panel 83, meaning each indicator zone is near the functional zone of the control panel that controls the corresponding function. Specifically, the buttons can be grouped by function, with each group of buttons on control panel 83 forming a functional zone. For example, buttons related to the lawn mower's power, such as the blade mode switch 134 and the self-traveling mode switch 136, are grouped into a power control group. The corresponding zone on the control panel 83 is called the power control zone. Buttons like the cutting speed adjustment switch 138 are grouped into a body settings group; the corresponding zone is the body settings zone. Safety-related buttons like an emergency stop button are grouped into a safety module group; the corresponding zone is the safety module zone. The self-propelled mode indicator zone 71 is near the power control zone. The speed mode indicator zone 74 is near the body settings zone. The load indicator zone 72, battery level indicator zone 73, maintenance indicator zone 75, and overtemperature indicator zone 76 are near the safety module zone.

In one embodiment, the button function and indicator zone are linked by color. For example, if the lawn mower 100 includes a red emergency stop button near the maintenance indicator zone 75, the red button may correspond to a maintenance indicator zone 75. Linking button color and indicator zone color aligns with the user's visual and sensory consistency.

In one embodiment, the surfaces of the buttons on the control panel 83 have textures, and buttons for different functions have different textures. For instance, buttons related to the lawn mower's power, such as the blade mode switch 134, the self-traveling mode switch 136, and the walking speed adjustment switch 137, have bump-like textures. Buttons like the light switch 135 have stripe-like textures. Differentiating button surface textures allows users to perceive the button function type through tactile feedback, reducing misoperation.

In one embodiment, when a button is operated, the corresponding indicator zone on the display screen 1403 related to the button's function highlights or flashes, providing dynamic guidance. For example, when the walking speed adjustment switch 137 is operated to set the walking speed, the speed mode indicator zone 74 on the display screen 1403 highlights, allowing the user to quickly see the speed change information. When the display screen 1403 is a touch-operable screen, it displays touch buttons. Clicking a touch button can similarly control the lawn mower 100 to perform the corresponding function. When operating related functions, the relevant operation area on the display screen 1403 can also be highlighted. For instance, when adjusting blade speed, the corresponding cutting speed adjustment touch button on the display screen 1403 flashes.

In one embodiment, the display content of the display screen 1403 automatically scales according to the screen size. For example, when the display screen 1403 is unfolded to 7 inches, the display content covers the entire screen, and the font size adapts to this 7-inch screen. When the display screen 1403 is folded down to 5 inches, the display content also shrinks proportionally, automatically adjusting information density to ensure clarity on the 5-inch screen. When the display screen 1403 is unfolded to a large screen, there is sufficient space to accommodate various touch buttons using a tiled menu layout, where menu buttons are spread out on the screen. When the display screen 1403 is smaller, a folded menu is used, where touch buttons are collapsed into the menu, and clicking the menu will pop up the individual touch buttons.

In one embodiment, the display screen 1403 can use split-screen display technology to partition relevant information. For example, the left side of the screen may fixedly display core parameters (e.g., walking speed, cutting speed), while the right side allows scrolling to view secondary information (non-core parameters, like history records). The font size of information can adaptively adjust based on importance. For example, key data such as core parameters may have a font size ≥14 pt, while secondary information may have a font size ≤12 pt. Font size can also adaptively adjust based on working time. For example, in daytime mode with good lighting and clear visibility, fonts can be set smaller. In nighttime mode, the font size automatically increases.

The display screen 1403 supports multi-page information display. For example, the lawn mower's relevant information contains 4 pages: Page 1 is blade mode selection, Page 2 is self-propelled speed adjustment, Page 3 is battery level display, and Page 4 is machine status display. The display screen 1403 supports page-turning settings for multi-page information, and the page-turning function can be activated through a physical button of the page-turning switch on the control panel 83. Activating the page-turning switch once will switch to the next page of content. For example, if Page 1 is currently displayed, activating the page-turning switch once displays Page 2. Activating the page-turning switch again displays Page 3, and so on. After Page 4, activating the page-turning switch again cycles back to Page 1. In one embodiment, the display screen 1403 also supports page turning via gesture swiping. For example, touching the display screen 1403 and swiping left is recognized as a left-swipe gesture, advancing to display the next page; touching the display screen 1403 and swiping right goes back to the previous page. In another embodiment, the display screen 1403 also supports page turning via voice commands. For example, when the user issues a “Page turn” or “Next page” voice command, the display screen 1403 receives and parses this voice command and executes turning to the next page. It can also support “Previous page” commands to go back, or commands to jump to a specific page.

Page 1 is the startup page, also referred to as the top page, and the display order of each page can be set by the user. By default, the first page is the startup page (i.e., the top page), and 4 pages of information automatically scroll. The display screen 1403 also supports a user defined top page feature, which can be controlled by the physical button of the top page switch, a touch button on the display screen 1403, or voice commands. For example, if the user considers Page 3, which displays the battery level, important, the user can set this page as the top page. After setting it as the top page, each time the device starts, Page 3 (battery level display) will be displayed first, and other pages will be displayed in order thereafter. The top page operation can be defined as long-pressing the top page button for 2 seconds or long-pressing the Page 3 display for 2 seconds. The specific operation method and long-press duration can be set according to the user's preferences and are not limited here. The display screen 1403 also supports the function of locking a page as a persistent page, meaning the screen will be fixed on that page without scrolling. For example, if the user considers the battery display to be very important, the user can lock this page as the persistent page. The locking operation can be performed through a physical button or a touch button. The locking operation can be defined as long-pressing the button for 3 seconds or long-pressing the page for 3 seconds. The specific operation method and long-press duration can be set according to the user's preferences.

The lawnmower 100 also supports map navigation functionality. The display screen 1403 displays an electronic map of the lawn work area, where each location point on the map corresponds to a specific position in the actual work area. The entire electronic map can also be displayed as a separate page of content, which scrolls along with the other four pages. The map can show the current location of the lawnmower 100, for example, by using a preset icon to represent the lawnmower 100. The position of this icon on the map represents the current location of the lawnmower 100 in the actual work area. The map can also display the cutting path planned for the work area, showing the completed and remaining paths with different display methods (such as different colors), allowing users to intuitively understand the cutting progress. The edge of the map can also display a miniature progress bar, where the total length of the progress bar represents the planned total path length, and the position of the lawnmower 100 icon on the progress bar indicates the current cutting progress. Similarly, the completed and remaining path lengths can be displayed using different display methods.

The display screen 1403 has a virtual button haptic feedback function. When the user operates a touch button on the screen, a linear motor inside the display screen 1403 simulates the tactile feel of a physical button, generating vibration feedback. The user can perceive whether the button has been pressed through the vibration, which helps reduce accidental touches. The virtual button haptic feedback function of the display screen 1403 can be toggled on or off through related settings, allowing the user to freely enable or disable this function, enhancing the user experience.

The display screen 1403 also supports an emergency lock function. By double-tapping the edge of the screen, the display screen 1403 can be locked. In the locked state, the button functions on the display screen 1403 are disabled, meaning that even if the buttons on the screen are tapped, no corresponding control will be executed. This helps prevent accidental operations in bumpy environments. The display screen 1403 can be unlocked by double-tapping the edge of the screen again.

Display screen 1403 also supports an emergency lock function. Double-clicking the edge of the screen locks display screen 1403. When locked, the buttons on display screen 1403 are disabled. Even if a button is clicked, the corresponding control will not be executed, preventing accidental operation in bumpy environments. Display screen 1403 can be unlocked by double-clicking the edge of the screen again.

As shown in FIG. 78, in one embodiment, the display 14 and the control panel 83 are detachable. The display 14 is connected to the connecting rod assembly 12 via a bracket 126, allowing the display 14 to be suspended above the connecting rod assembly 12, avoiding obstruction from the handle device 13, so that the user's line of sight to the display 14 is unobstructed. Specifically, as shown in FIG. 79, one end of the bracket 126 is connected to one side of the display 14, and the other end is connected to a transverse connecting structure 124. The bracket 126 is made of transparent material, and the height H of the display 14 from the ground is greater than or equal to 80 cm. The height of the display 14 from the ground refers to the vertical distance from the lower boundary edge of the display 14 to the ground.

The bracket 126 is adjustable and can regulate the height of the display 14 from the ground. Specifically, the other end of the bracket 126 can extend or retract within the transverse connecting structure 124, meaning the lower part of the bracket can be telescoped, allowing the bracket 126 to slide up and down. The height adjustment range is less than or equal to 5 cm to accommodate different user heights and viewing angles. In one embodiment, the bracket 126 can also be fully retracted into the transverse connecting structure 124. When the display 14 needs to be suspended, the bracket 126 is extended to lift the display 14. When the display height adjustment is not needed, especially when the mower 100 is folded, the bracket 126 is retracted into the transverse connecting structure 124, avoiding interference with other mechanical parts of the machine.

As shown in FIG. 80, in one embodiment, the body 11 also includes a housing 114, and the body 11 is at least partially housed inside the housing 114, with the display 14 positioned above the rear end of the housing 114. Specifically, the connecting rod assembly 12 is pivotally connected to the body 11 via a hinge 127, with the axis of the hinge 127 being the pivot axis 102. The hinge 127 is housed within the housing 114, meaning the display 14 is positioned above the rear end of the body 11, near the upper corresponding part of the housing 114 above the hinge 127, with the display screen 1403 facing the user. In this case, the user's standing position is at the handle part 131, and the user's movement direction aligns with the mower 100's movement direction.

One edge of the display 14 is rotationally connected to the housing 114, allowing the display screen 1403 of the display to adjust its orientation. Specifically, as shown in FIG. 80, the bottom edge of the display 14 is connected to the housing 114, allowing the display to rotate along the front-back direction. A groove-shaped screen storage compartment 115 is located near the position of the display 14 at the rear end of the housing 114. The screen storage compartment 115 is integrally formed with the housing 114, forming a storage compartment above the rear end of the housing 114. The display 14 can be rotated and stored inside the screen storage compartment 115. When in use, the display 14 is rotated outward, raising the screen 1403 to face the user, ensuring that the screen display range is within the user's line of sight. As shown in FIG. 81, when the mower 100 is folded, the display 14 is rotated into the screen storage compartment 115, fully or partially stored inside it. The display 14 is stored along with the folding of the connecting rod assembly 12, avoiding interference with the mower 100's mechanical parts and providing protection for the display 14.

A slide rail 1405 may be provided at the connection between the display 14 and the housing 114. One side of the display 14 is connected to the slide rail 1405 and movable along the slide rail 1405. The slide rail 1405 is arranged along the left-right direction. When folding, the display 14 can slide along the slide rail 1405 to avoid interference with the mower 100's mechanical parts, thereby protecting both the display 14 and the mechanical components. For example, the display 14 can slide along the slide rail 1405 and also rotate forward or backward around the rail 1405.

The inner wall of the screen storage compartment 115 may be covered with a silicone pad to prevent the display 14 from being damaged by collisions. The screen storage compartment 115 may also be equipped with a matching storage cover that can selectively seal the opening of the screen storage compartment 115. When storing, the storage cover is closed to block the opening of the screen storage compartment 115, preventing debris from entering the compartment and better protecting the display screen 1403. When the display 14 is needed, the storage cover is opened, and the display 14 is rotated outward. The storage cover is then closed to seal the opening of the screen storage compartment 115.

In one embodiment, the display 14 may be further configured to automatically retract in synchronization with the folding operation. A rotation angle sensor is provided near the hinge 127 to detect whether a folding action occurs in the connecting rod assembly 12. Specifically, the rotation angle sensor detects the rotational angle of the hinge 127. When the detected rotation angle meets a preset condition, it is determined that the connecting rod assembly 12 is undergoing a folding action. When a folding event of the connecting rod assembly 12 is detected or when the folding angle reaches the preset condition, the display 14 is driven to automatically rotate relative to the housing 114 into the screen storage compartment 115 for synchronized storage. The folding angle refers to the angle between the extension direction of the connecting rod assembly 12 and the horizontal direction of the body. For example, when the folding angle is less than or equal to 30°, the display screen 1403 automatically retracts into the screen storage compartment 115. When the folding is completed, the display screen 1403 enters sleep mode to reduce energy consumption.

It can also be understood that the system can simultaneously detect whether the connecting rod assembly 12 is unfolding. When the unfolding action is detected or completed, the display 14 is driven to rotate upward for the user to view, meaning the display 14 can be used once the handle device 13 is extended.

FIGS. 62 to 65 disclose more examples of the storage box of the walk-behind working machine. Items such as a mobile phone, a key, and a bottle may be placed in a storage box 451. In some examples, storage boxes (441, 451, and 461) are adapted to the walk-behind mower. FIGS. 62 and 63 show the storage box 451, and FIGS. 64 and 65 show the storage box 461. In conjunction with FIGS. 31 and 32, in an example, both the storage box 451 and the storage box 461 may be mounted on the first mounting portion 42 on the switch box 411. Similar to the storage box 441 disclosed in FIG. 31, the storage box 451 is also disposed on the lower side of the handle 412.

The storage box 451 includes an accommodation body 4512, and the accommodation body 4512 forms a first accommodation space 450. The first accommodation space 450 may be open or closed. In an example, the storage box 451 includes a cover 4511. When the cover 4511 is closed, the accommodation body 4512 and the cover 4511 together surround the closed first accommodation space 450. A connection assembly 4513 is disposed at a position where the cover 4511 is connected to the accommodation body 4512. In an example, the connection assembly 4513 is a zipper. In other examples, the connection assembly 4513 may implement the connection function through various connection manners such as a magnetic buckle, Velcro, and a snap.

The storage box or the accommodation body 4512 may be made of hard materials such as plastic or flexible materials such as linen. In an example, the accommodation body 4512 may be made of hard materials and flexible materials, for example, a hard frame and flexible fabric. That is to say, the name of the “storage box” cannot limit the storage box 451 to be a type of box, and the “storage box” may be a flexible bag.

In an example, the storage box 451 further has a second accommodation space 4514, and the volume of the second accommodation space 4514 is less than the volume of the first accommodation space 450. In other words, the storage box 451 may have two or more independent accommodation spaces for placing different items without interfering with each other.

As shown in FIGS. 64 and 65, the storage box 461 does not include the cover 4511, and the accommodation body 4512 forms the open first accommodation space 450. The storage box 461 may include hooks 4612, and the hooks 4612 may be used for hanging items such as keys. The storage box 461 further includes bottle grooves 4611, and an arc-shaped housing may form at least one bottle groove 4611 for placing the bottle. In addition, a bottle bag 4613 is disposed on the side of the storage box 461, and the bottle bag 4613 may be made of flexible materials such as a net bag and canvas. Each of the bottle groove 4611 and the bottle bag 4613 may be configured to be a telescopic structure, such as an elastic net bag or a groove with a movable housing, so as to accommodate bottles of different dimensions and place the bottles stably.

As shown in FIG. 65, in an example, the storage box 461 is basically in the shape of a cuboid, the length X of the storage box 461 is less than or equal to 600 mm, the height Z is less than or equal to 500 mm, and the width Y is less than or equal to 300 mm. The height Z of the storage box 461 is basically parallel to the extension direction of the connecting rod 4122, and the length X of the storage box 461 is basically parallel to the extension direction of the locking rod 231. It is to be noted that the length X, the height Z, and the width Y are all the measured distances of the outer surface of the storage box 461, rather than the dimensions of the internal first accommodation space 450.

The volume of the first accommodation space 450 is less than or equal to 70 L. In some examples, the volume of the first accommodation space 450 may be approximately 30 L, 40 L, 50 L, or 60 L. The total mass of the items that can be placed in the storage box is less than or equal to 10 kg. In some examples, the total mass of the items that can be placed in the storage box may be 4 kg, 5 kg, 6 kg, or 7 kg.

It is to be noted that the walk-behind working machine involved in the present application may be the walk-behind mower or the snow thrower or may be another push tool, such as a small irrigation machine, a sprinkler, a push blower, or any type of garden and agricultural power tool.

The basic principles, main features, and advantages of the present application are shown and described above. It is to be understood by those skilled in the art that the preceding examples do not limit the present application in any form, and all technical solutions obtained through equivalent substitutions or equivalent transformations fall within the scope of the present application.

What is claimed is:

1. A walk-behind working machine, comprising:
a body comprising a wheel assembly and a working assembly;
a handle device comprising a grip for a user to hold;
a connecting rod assembly connecting the handle device to the body and comprising a first end facing away from the body and a second end pivotally connected to the body around a pivot axis; and
a display capable of displaying information related to the walk-behind working machine, wherein a screen of the display faces toward the user, and is not blocked when the user holds the handle device, and a distance L1 between the first end of the connecting rod assembly and a lower boundary of the screen is greater than 70 mm.

2. The walk-behind working machine of claim 1, wherein the working assembly is a cutting assembly, and the walk-behind working machine is a lawn mower.

3. The walk-behind working machine of claim 1, wherein a distance L2 between a centerline of the handle device and the lower boundary of the screen is greater than 50 mm.

4. The walk-behind working machine of claim 1, wherein a distance between the first end of the connecting rod assembly and the pivot axis is L3 and L1/L3>0.1.

5. The walk-behind working machine of claim 1, wherein the display is configured to be slidably and/or rotatably connected to the handle device.

6. The walk-behind working machine of claim 1, wherein the display is configured to be suspended above the connecting rod assembly.

7. A walk-behind working machine, comprising:
a body comprising a wheel assembly and a working assembly;
a handle device comprising a grip for a user to hold;
a connecting rod assembly connecting the handle device to the body and pivotally connected to the body around a pivot axis; and
a display capable of displaying information related to the walk-behind working machine, and the display is disposed between the handle device and the pivot axis.

8. The walk-behind working machine of claim 7, wherein the display is detachable, and at least two installation positions for setting the display are provided between the handle device and the pivot axis.

9. The walk-behind working machine of claim 7, wherein the display or a mounting portion for mounting the display is disposed on the connecting rod assembly.

10. The walk-behind working machine of claim 9, wherein the display is rotatably disposed on a first connecting rod of the connecting rod assembly.

11. The walk-behind working machine of claim 7, wherein a plurality of switches is disposed in proximity to the display.

12. The walk-behind working machine of claim 7, wherein the connecting rod assembly is foldable above the body for easy storage.

13. A walk-behind working machine, comprising:
a body comprising a wheel assembly and a working assembly;
a handle device comprising a grip for a user to hold;
a connecting rod assembly for connecting the handle device to the body;
a display capable of displaying information related to the walk-behind working machine, wherein the display or a mounting portion for mounting the display is disposed on the handle device; and
a switch disposed in proximity to the display wherein the display is lit when the switch is activated.

14. The walk-behind working machine of claim 13, wherein the switch is a display switch.

15. The walk-behind working machine of claim 14, wherein, when the user triggers the display switch to light up the display, information of a blade mode is displayed on the display; and a change of the blade mode triggered by a blade mode switch is displayed on the display.

16. The walk-behind working machine of claim 14, wherein, when the user triggers the display switch to light up the display, information of a self-traveling mode is displayed on the display; and a change of the self-traveling mode triggered by a self-traveling mode switch is displayed on the display.

17. The walk-behind working machine of claim 14, wherein a lighting state and brightness mode of a light of the walk-behind working machine is displayed on the display.

18. The walk-behind working machine of claim 13, wherein the switch is not dedicated to light up the display, and the switch is any one of a blade mode switch, a self-traveling mode switch, and a light switch.

19. The walk-behind working machine of claim 18, wherein a first activation of the switch lights up the display, and a subsequent activation of the same switch performs its original function.

20. The walk-behind working machine of claim 13, wherein lighting up of the display is achieved by activation of a combination of multiple switches.
